(19) United States
(12) Patent Application Publication
(10) Pub. No.: US 2026/0072233 A1
(43) Pub. Date: Mar. 12, 2026

(54) IMAGING LENS ASSEMBLY, CAMERA MODULE, ELECTRONIC DEVICE AND MOBILE TRANSPORTATION

(71) Applicant: LARGAN PRECISION CO., LTD., Taichung City (TW)

(72) Inventors: Lin-An CHANG, Taichung City (TW); Shen Wu HSIAO, Taichung City (TW); Hsuan-Chin HUANG, Taichung City (TW)

(21) Appl. No.: 19/312,524

(22) Filed: Aug. 28, 2025

(30) Foreign Application Priority Data
Sep. 6, 2024 (TW) 113133800

(51) Int. Cl. G02B 7/02

(52) U.S. Cl. CPC G02B 7/021

(57) ABSTRACT

An imaging lens assembly has an optical axis, and includes a plurality of lens elements, an annular light blocking structure, a plastic lens barrel, an object-side retainer and an image-side retainer. The lens elements include an object-side lens element and an image-side lens element, and the object-side lens element, the annular light blocking structure and the image-side lens element are disposed in order along the optical axis from an object side of the imaging lens assembly to an image side of the imaging lens assembly. The annular light blocking structure includes a light blocking surface, an object-side surface, an image-side surface and a plurality of strip-shaped wedge structures. The plastic lens barrel includes an object-side portion, an image-side portion, an inner peripheral portion and an outer peripheral portion. The object-side retainer includes an object-side retaining portion and an object-side abutting portion.

### RELATED APPLICATIONS

This application claims priority to Taiwan Application Serial Number 113133800, filed Sep. 6, 2024, which is herein incorporated by reference.

### BACKGROUND

### Technical Field

The present disclosure relates to an imaging lens assembly and a camera module. More particularly, the present disclosure relates to an imaging lens assembly and a camera module applicable to portable electronic devices and mobile transportations.

### Description of Related Art

In the recent years, portable electronic devices have developed rapidly. For example, intelligent electronic devices and tablets have been filled in the lives of modern people, and camera modules and imaging lens assemblies mounted on portable electronic devices and mobile transportations have also prospered. However, as technology advances, the quality requirements of the imaging lens assemblies are becoming higher and higher. Therefore, an imaging lens assembly, which can ensure the assembling feasibility of products and provide the higher optical quality, needs to be developed.

### SUMMARY

According to one aspect of the present disclosure, an imaging lens assembly has an optical axis, and includes a plurality of lens elements, an annular light blocking structure, a plastic lens barrel, an object-side retainer and an image-side retainer. The lens elements are disposed in order along the optical axis, wherein the lens elements include an object-side lens element and an image-side lens element. The object-side lens element, the annular light blocking structure and the image-side lens element are disposed in order along the optical axis from an object side of the imaging lens assembly to an image side of the imaging lens assembly, and the annular light blocking structure includes a light blocking surface, an object-side surface, an image-side surface and a plurality of strip-shaped wedge structures. The light blocking surface is disposed around and faces towards the optical axis. The object-side surface faces towards the object side of the imaging lens assembly, and extends from the light blocking surface in a direction away from the optical axis. The image-side surface faces towards the image side of the imaging lens assembly, and extends from the light blocking surface in the direction away from the optical axis. The strip-shaped wedge structures are disposed on the light blocking surface, wherein each of the strip-shaped wedge structures extends from the object-side surface to the image-side surface, the strip-shaped wedge structures are arranged in a direction surrounding the optical axis, each of the strip-shaped wedge structures includes a tapering portion, and the tapering portion tapers towards the optical axis. The lens elements and the annular light blocking structure are disposed in the plastic lens barrel, and the plastic lens barrel includes an object-side portion, an image-side portion, an inner peripheral portion and an outer peripheral portion. The object-side portion faces towards the object side of the imaging lens assembly and forms an object-side opening, wherein the object-side lens element is placed into the plastic lens barrel from the object-side opening to the object-side surface. The image-side portion faces towards the image side of the imaging lens assembly and forms an image-side opening, wherein the image-side lens element is placed into the plastic lens barrel from the image-side opening to the image-side surface. The inner peripheral portion connects the object-side portion and the image-side portion, and is disposed facing towards the optical axis. The outer peripheral portion connects the object-side portion and the image-side portion, and is disposed corresponding to the inner peripheral portion in the direction away from the optical axis. The object-side retainer is disposed on the object-side portion of the plastic lens barrel, and includes an object-side retaining portion and an object-side abutting portion. The object-side retaining portion surrounds the outer peripheral portion of the plastic lens barrel. The object-side abutting portion extends from the object-side retaining portion towards the optical axis, and abuts the object-side lens element so as to fix the object-side lens element to the object-side portion of the plastic lens barrel. The image-side retainer is disposed on the image-side portion of the plastic lens barrel so as to fix the image-side lens element to the image-side portion of the plastic lens barrel. When a minimum diameter of the object-side retainer is Do, a minimum diameter of the image-side retainer is Di, and a minimum diameter of the light blocking surface is Ds, the following condition is satisfied: 0.03<Ds/(Do+Di)<0.75.

According to one aspect of the present disclosure, an imaging lens assembly has an optical axis, and includes a plurality of lens elements, an annular light blocking structure, a plastic lens barrel, an object-side retainer and an image-side retainer. The lens elements are disposed in order along the optical axis, wherein the lens elements include an object-side lens element and an image-side lens element. The object-side lens element, the annular light blocking structure and the image-side lens element are disposed in order along the optical axis from an object side of the imaging lens assembly to an image side of the imaging lens assembly, and the annular light blocking structure includes a light blocking surface, an object-side surface, an image-side surface and a plurality of strip-shaped wedge structures. The light blocking surface is disposed around and faces towards the optical axis. The object-side surface faces towards the object side of the imaging lens assembly, and extends from the light blocking surface in a direction away from the optical axis. The image-side surface faces towards the image side of the imaging lens assembly, and extends from the light blocking surface in the direction away from the optical axis. The strip-shaped wedge structures are disposed on the light blocking surface, wherein each of the strip-shaped wedge structures extends from the object-side surface to the image-side surface, the strip-shaped wedge structures are arranged in a direction surrounding the optical axis, each of the strip-shaped wedge structures includes a tapering portion, and the tapering portion tapers towards the optical axis. The lens elements and the annular light blocking structure are disposed in the plastic lens barrel, and the plastic lens barrel includes an object-side portion, an image-side portion, an inner peripheral portion and an outer peripheral portion. The object-side portion faces towards the object side of the imaging lens assembly and forms an object-side opening, wherein the object-side lens element is placed into the plastic lens barrel from the object-side opening to the object-side surface. The image-side portion faces towards the image side of the imaging lens assembly and forms an image-side opening, wherein the image-side lens element is placed into the plastic lens barrel from the image-side opening to the image-side surface. The inner peripheral portion connects the object-side portion and the image-side portion, and is disposed facing towards the optical axis. The outer peripheral portion connects the object-side portion and the image-side portion, and is disposed corresponding to the inner peripheral portion in the direction away from the optical axis. The object-side retainer is disposed on the object-side portion of the plastic lens barrel, and includes an object-side retaining portion and an object-side abutting portion. The object-side retaining portion surrounds the outer peripheral portion of the plastic lens barrel. The object-side abutting portion extends from the object-side retaining portion towards the optical axis, and abuts the object-side lens element so as to fix the object-side lens element to the object-side portion of the plastic lens barrel. The image-side retainer is disposed on the image-side portion of the plastic lens barrel so as to fix the image-side lens element to the image-side portion of the plastic lens barrel. When a distance between the object-side abutting portion of the object-side retainer and the object-side surface of the annular light blocking structure in a direction parallel to the optical axis is Lr, and a length of the object-side retainer in the direction parallel to the optical axis is Lo, the following condition is satisfied: 0.15<Lr/Lo<1.

According to one aspect of the present disclosure, a camera module includes the imaging lens assembly of the aforementioned aspect.

According to one aspect of the present disclosure, an electronic device includes the camera module of the aforementioned aspect.

According to one aspect of the present disclosure, a mobile transportation includes the camera module of the aforementioned aspect.

### BRIEF DESCRIPTION OF THE DRAWINGS

The present disclosure can be more fully understood by reading the following detailed description of the embodiment, with reference made to the accompanying drawings as follows:

FIG. 1A is a three-dimensional view of an imaging lens assembly according to the 1st Embodiment of the present disclosure.

FIG. 1B is an exploded view of the imaging lens assembly according to the 1st Embodiment in FIG. 1A.

FIG. 1C is a schematic side view of the imaging lens assembly according to the 1st Embodiment in FIG. 1A.

FIG. 1D is a cross-sectional view of the imaging lens assembly along a cross line 1D-1D according to the 1st Embodiment in FIG. 1C.

FIG. 1E is a cross-sectional view of the imaging lens assembly according to the 1st Embodiment in FIG. 1A.

FIG. 1F is a partial enlarged view of the annular light blocking structure disposed on the spacer according to the 1st Embodiment in FIG. 1A.

FIG. 1G is a three-dimensional view of the annular light blocking structure disposed on the spacer according to the 1st Embodiment in FIG. 1A.

FIG. 1H is an enlarged schematic view of strip-shaped wedge structures according to the 1st Embodiment in FIG. 1G.

FIG. 1I is a three-dimensional view of the annular light blocking structure disposed on the spacer according to the 1st Embodiment in FIG. 1A.

FIG. 1J is an enlarged schematic view of strip-shaped wedge structures according to the 1st Embodiment in FIG. 1I.

FIG. 1K is a schematic view of parameters of the imaging lens assembly according to the 1st Embodiment in FIG. 1A.

FIG. 1L is another schematic view of parameters of the imaging lens assembly according to the 1st Embodiment in FIG. 1A.

FIG. 2A is a three-dimensional view of an imaging lens assembly according to the 2nd Embodiment of the present disclosure.

FIG. 2B is an exploded view of the imaging lens assembly according to the 2nd Embodiment in FIG. 2A.

FIG. 2C is a schematic side view of the imaging lens assembly according to the 2nd Embodiment in FIG. 2A.

FIG. 2D is a cross-sectional view of the imaging lens assembly along a cross line 2D-2D according to the 2nd Embodiment in FIG. 2C.

FIG. 2E is a cross-sectional view of the imaging lens assembly according to the 2nd Embodiment in FIG. 2A.

FIG. 2F is a three-dimensional view of an annular light blocking structure disposed on an inner peripheral portion of a plastic lens barrel according to the 2nd Embodiment in FIG. 2A.

FIG. 2G is an enlarged schematic view of strip-shaped wedge structures according to the 2nd Embodiment in FIG. 2F.

FIG. 2H is a schematic view of parameters of the imaging lens assembly according to the 2nd Embodiment in FIG. 2A.

FIG. 2I is another schematic view of parameters of the imaging lens assembly according to the 2nd Embodiment in FIG. 2A.

FIG. 3A is a schematic view of an electronic device according to the 3rd Embodiment of the present disclosure.

FIG. 3B is another schematic view of the electronic device according to the 3rd Embodiment in FIG. 3A.

FIG. 3C is a schematic view of an image captured via the electronic device according to the 3rd Embodiment in FIG. 3A.

FIG. 3D is a schematic view of another image captured via the electronic device according to the 3rd Embodiment in FIG. 3A.

FIG. 3E is a schematic view of another image captured via the electronic device according to the 3rd Embodiment in FIG. 3A.

FIG. 4 is a schematic view of an electronic device according to the 4th Embodiment of the present disclosure.

FIG. 5A is a schematic view of a mobile transportation according to the 5th Embodiment of the present disclosure.

FIG. 5B is another schematic view of the mobile transportation according to the 5th Embodiment in FIG. 5A.

FIG. 5C is another schematic view of the mobile transportation according to the 5th Embodiment in FIG. 5A.

### DETAILED DESCRIPTION

The present disclosure provides an imaging lens assembly, which has an optical axis and includes a plurality of lens elements, an annular light blocking structure, a plastic lens barrel, an object-side retainer and an image-side retainer.

The lens elements are disposed in order along the optical axis, wherein the lens elements include an object-side lens element and an image-side lens element. The object-side lens element, the annular light blocking structure and the image-side lens element are disposed in order along the optical axis from an object side of the imaging lens assembly to an image side of the imaging lens assembly, and the annular light blocking structure includes a light blocking surface, an object-side surface, an image-side surface and a plurality of strip-shaped wedge structures. The light blocking surface is disposed around and faces towards the optical axis. The object-side surface faces towards the object side of the imaging lens assembly, and extends from the light blocking surface in a direction away from the optical axis. The image-side surface faces towards the image side of the imaging lens assembly, and extends from the light blocking surface in the direction away from the optical axis. The strip-shaped wedge structures are disposed on the light blocking surface, each of the strip-shaped wedge structures extends from the object-side surface to the image-side surface, and the strip-shaped wedge structures are arranged in a direction surrounding the optical axis, wherein each of the strip-shaped wedge structures includes a tapering portion, and the tapering portion tapers towards the optical axis. In detail, the object-side lens element is the lens element most close to the object side, and the image-side lens element is the lens element most close to the image side.

The lens elements and the annular light blocking structure are disposed in the plastic lens barrel, and the plastic lens barrel includes an object-side portion, an image-side portion, an inner peripheral portion and an outer peripheral portion. The object-side portion faces towards the object side of the imaging lens assembly and forms an object-side opening, and the object-side lens element is placed into the plastic lens barrel from the object-side opening to the object-side surface. The image-side portion faces towards the image side of the imaging lens assembly and forms an image-side opening, and the image-side lens element is placed into the plastic lens barrel from the image-side opening to the image-side surface. The inner peripheral portion connects the object-side portion and the image-side portion, and is disposed facing towards the optical axis. The outer peripheral portion connects the object-side portion and the image-side portion, and is disposed corresponding to the inner peripheral portion in the direction away from the optical axis.

The object-side retainer is disposed on the object-side portion of the plastic lens barrel, and the object-side retainer includes an object-side retaining portion and an object-side abutting portion. The object-side retaining portion surrounds the outer peripheral portion of the plastic lens barrel. The object-side abutting portion extends from the object-side retaining portion towards the optical axis, and abuts the object-side lens element so as to fix the object-side lens element to the object-side portion of the plastic lens barrel. Moreover, the fixing method of the object-side retaining portion and the plastic lens barrel and the fixing method of an image-side retaining portion and the plastic lens barrel can be the buckle fixing, thread engagement or glue adhesion, but not limited thereto. Furthermore, the object-side retainer can be made of metal materials or alloy materials, wherein the metal materials or the alloy materials can include magnesium, aluminum, silicon, titanium, vanadium, chromium, manganese, iron, cobalt, nickel, copper, zinc, gold, silver, gallium, germanium, tin, lead or molybdenum, but not limited thereto.

The image-side retainer is disposed on the image-side portion of the plastic lens barrel so as to fix the image-side lens element to the image-side portion of the plastic lens barrel.

Specifically, the present disclosure provides the imaging lens assembly assembled two-directionally, each of the lens elements is assembled through two retainers with the design of the annular light blocking structure so as to ensure the assembling feasibility of products and to provide the better optical quality. The externally wrapped object-side retainer can protect the structure of the imaging lens assembly and improve the environmental tolerance of the imaging lens assembly so as to extend the product service life. The interference of the stray light can be reduced and the better image recognizing ability can be provided in an environment with strong sunlight or in a dark night environment through the design of the strip-shaped wedge structures. The design of the annular light blocking structure with the object-side retainer is favorable for preventing the annular light blocking structure from the deformation due to the environmental temperature variation.

When a minimum diameter of the object-side retainer is Do, a minimum diameter of the image-side retainer is Di, and a minimum diameter of the light blocking surface is Ds, the following condition can be satisfied: 0.03<Ds/(Do+Di)<0.75. The better image resolution can be obtained and the product reliability is ensured simultaneously through the appropriate ratio of the opening of the plastic lens barrel to the opening of the light blocking surface. Moreover, the following condition can be satisfied: 0.05<Ds/(Do+Di)<0.55. Therefore, the production yield can be further improved via the annular light blocking structure. Furthermore, the following condition can be satisfied: 0.08<Ds/(Do+Di)<0.45. Therefore, the stray light resistance effect can be further provided.

When a distance between the object-side abutting portion of the object-side retainer and the object-side surface of the annular light blocking structure in a direction parallel to the optical axis is Lr, and a length of the object-side retainer in the direction parallel to the optical axis is Lo, the following condition can be satisfied: 0.15<Lr/Lo<1. Moreover, the following condition can be satisfied: 0.20<Lr/Lo<0.85. Therefore, the better assembling stability of the imaging lens assembly can be provided.

The object-side lens element can be made of a glass material, and the image-side lens element can be made of a plastic material. Therefore, the imaging lens assembly composed by a glass lens element and a plastic lens element can be taken account of the temperature effect and can satisfy the microminiaturization requirement.

The object-side lens element can include a convex surface, wherein the convex surface faces towards the object side of the imaging lens assembly. Therefore, the better light collecting effect can be provided, and it is favorable for improving the image recognizing ability.

The object-side abutting portion of the object-side retainer can have a first alignment structure, the object-side lens element can have a second alignment structure, and the first alignment structure and the second alignment structure rely to each other so as to align the object-side lens element to the optical axis of the imaging lens assembly. Therefore, it is favorable for simplifying the assembling process.

The annular light blocking structure can be disposed on the inner peripheral portion of the plastic lens barrel, and the annular light blocking structure on the inner peripheral portion extends from the inner peripheral portion to the optical axis. The stray light can be reduced through disposing the annular light blocking structure so as to improve the optical imaging quality.

The annular light blocking structure can be disposed on a spacer of the imaging lens assembly, and the spacer is disposed between two of the lens elements. The stray light can be reduced through disposing the annular light blocking structure so as to improve the optical imaging quality.

The image-side retainer can include an image-side retaining portion and an image-side abutting portion, wherein the image-side retaining portion surrounds the outer peripheral portion of the plastic lens barrel, and the image-side abutting portion extends from the image-side retaining portion towards the optical axis and abuts the image-side lens element. The overall structure of the imaging lens assembly can be protected through the externally wrapped image-side retainer, and the environmental tolerance of the imaging lens assembly can be improved so as to extend the product service life.

When a distance between the object-side surface and the image-side surface in a direction parallel to the optical axis is La, and the minimum diameter of the light blocking surface is Ds, the following condition can be satisfied: 0.02<La/Ds<1. Therefore, the suitable molding conditions of the strip-shaped wedge structures can be provided. Moreover, the following condition can be satisfied: 0.03<La/Ds<0.8. Therefore, the better light blocking efficiency can be provided.

When the minimum diameter of the object-side retainer is Do, the minimum diameter of the image-side retainer is Di, and the minimum diameter of the light blocking surface is Ds, the following condition can be satisfied: |Do−Di|<Ds. Therefore, the production yield of the annular light blocking structure can be improved.

When an angle formed between each of the strip-shaped wedge structures and the optical axis is As, the following condition can be satisfied: 0 degrees≤As<60 degrees. Therefore, the light blocking efficiency of the annular light blocking structure can be further improved. Moreover, the following condition can be satisfied: 0 degrees≤As<45 degrees. Therefore, the structural integrity of the strip-shaped wedge structures can be improved.

Each of the aforementioned features of the imaging lens assembly can be utilized in various combinations for achieving the corresponding effects.

The present disclosure provides a camera module, which includes the aforementioned imaging lens assembly.

The present disclosure provides an electronic device, which includes the aforementioned camera module.

The present disclosure provides a mobile transportation, which includes the aforementioned camera module.

According to the aforementioned embodiment, specific examples are provided, and illustrated via figures.

### 1st Embodiment

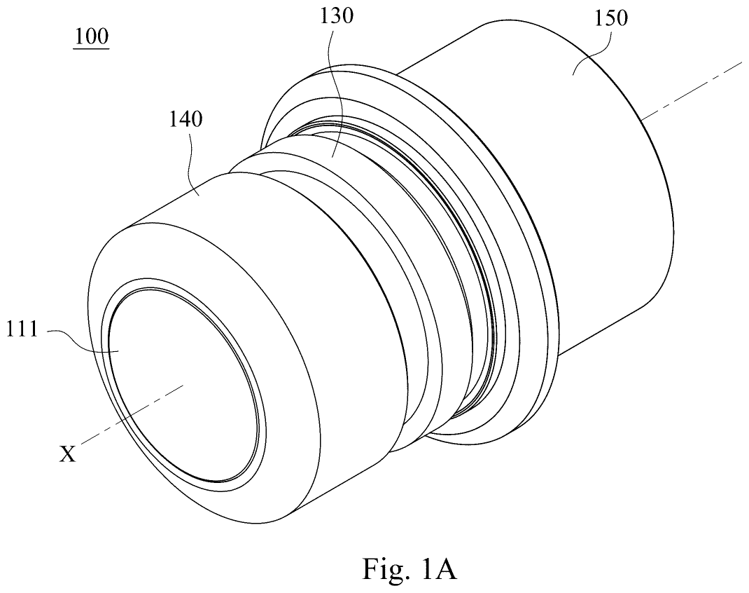

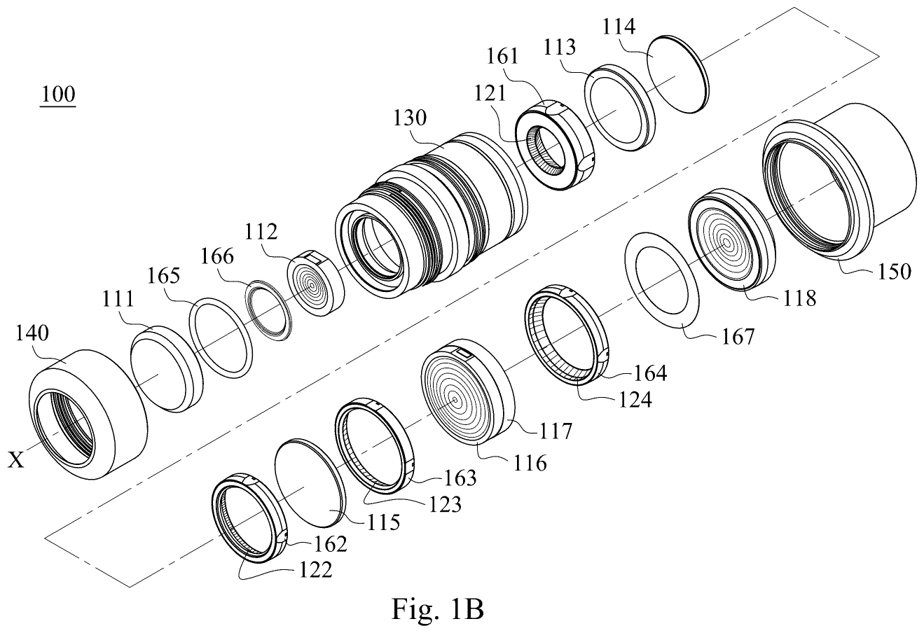

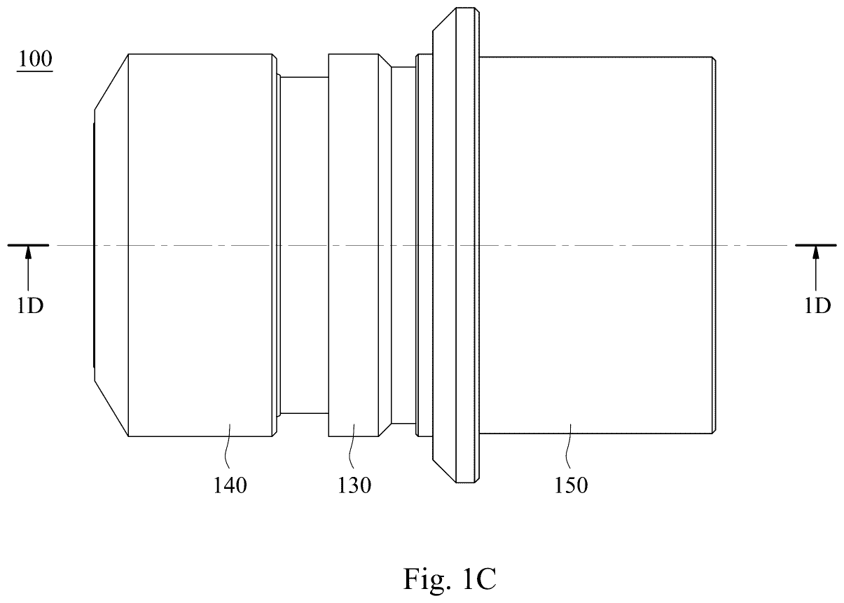

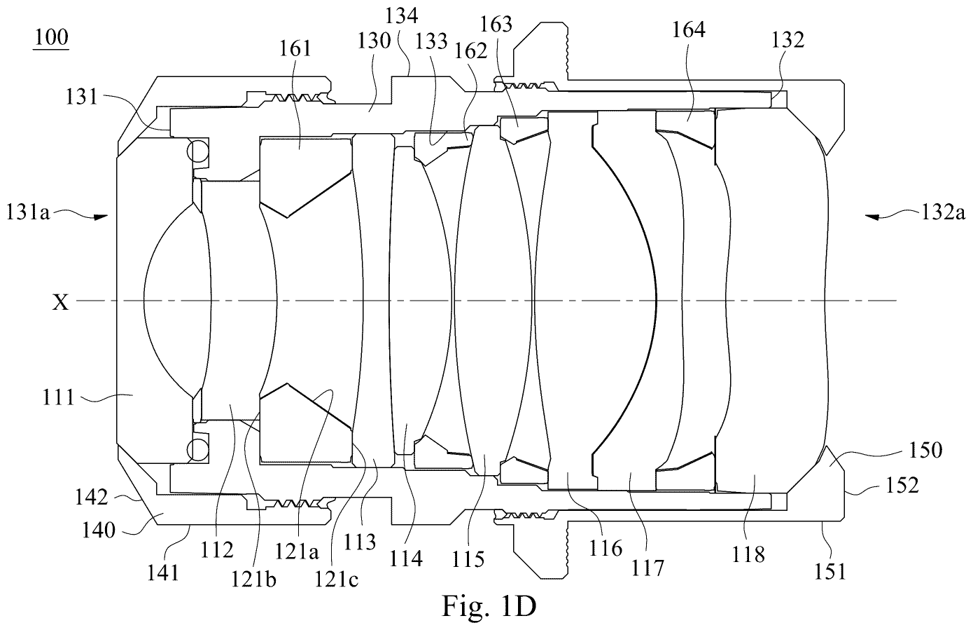

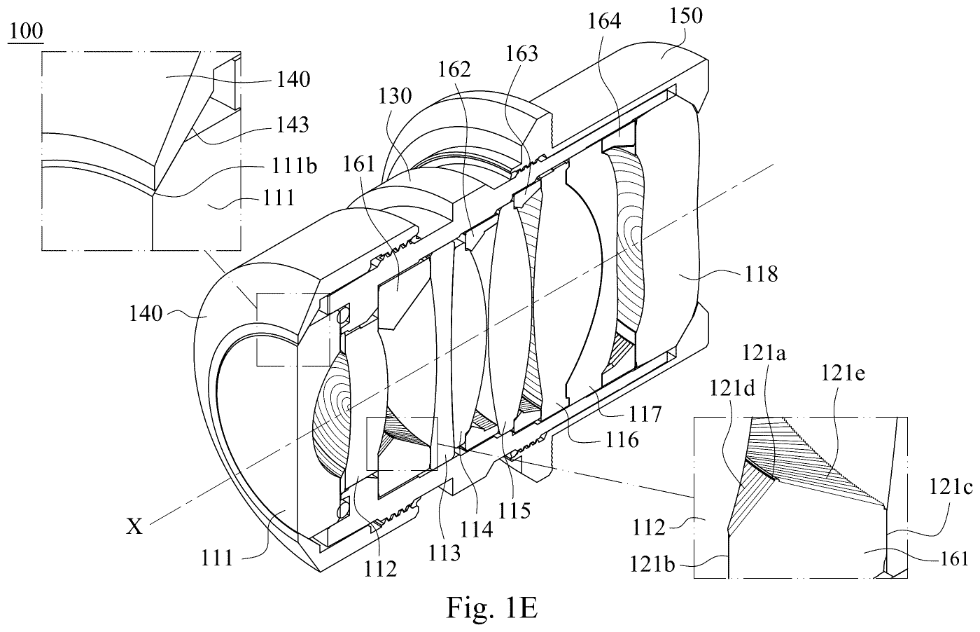

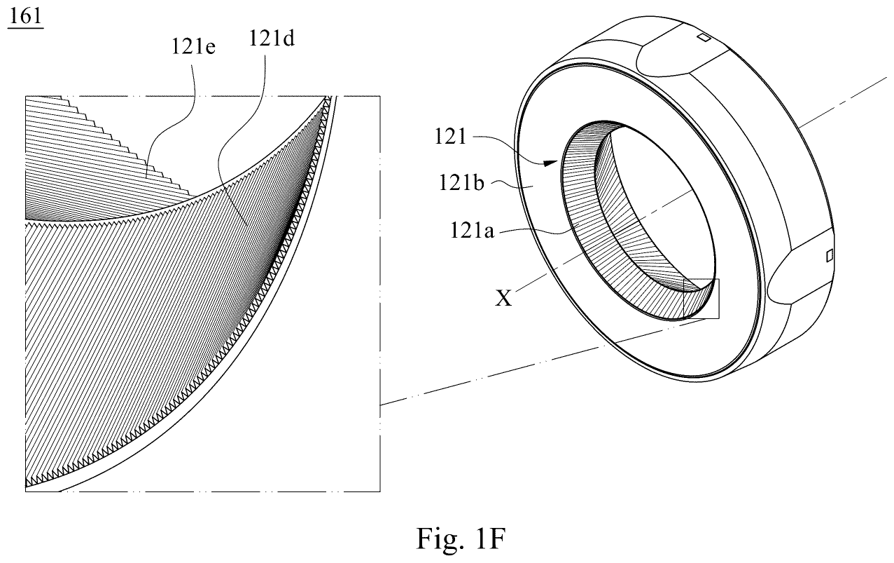

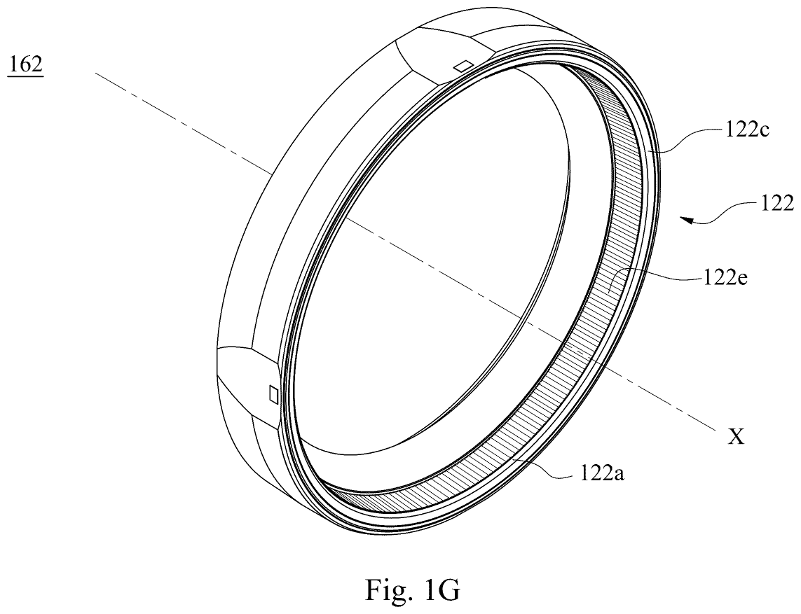

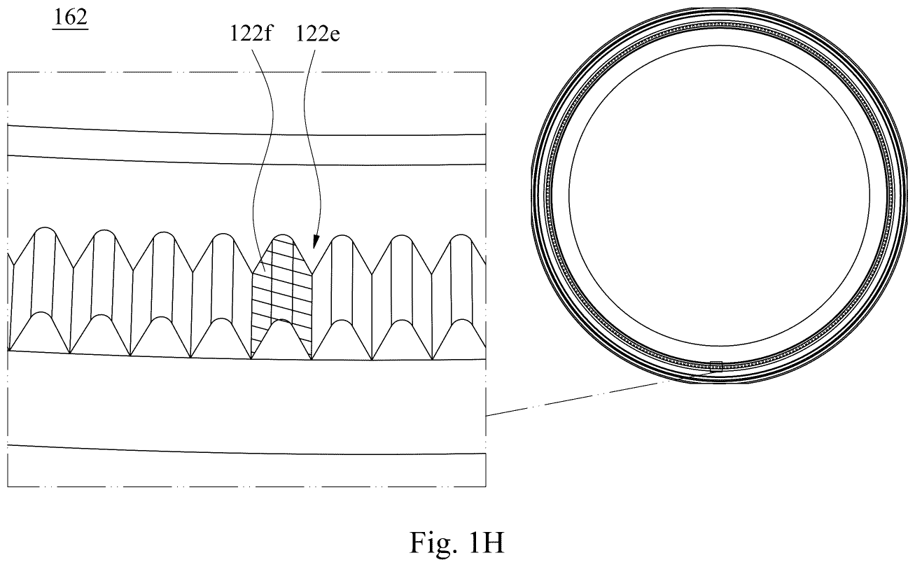

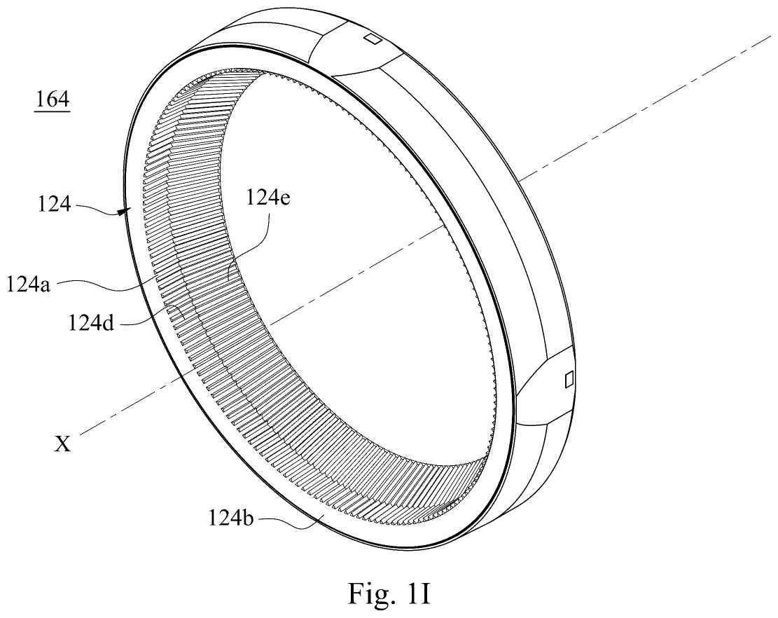

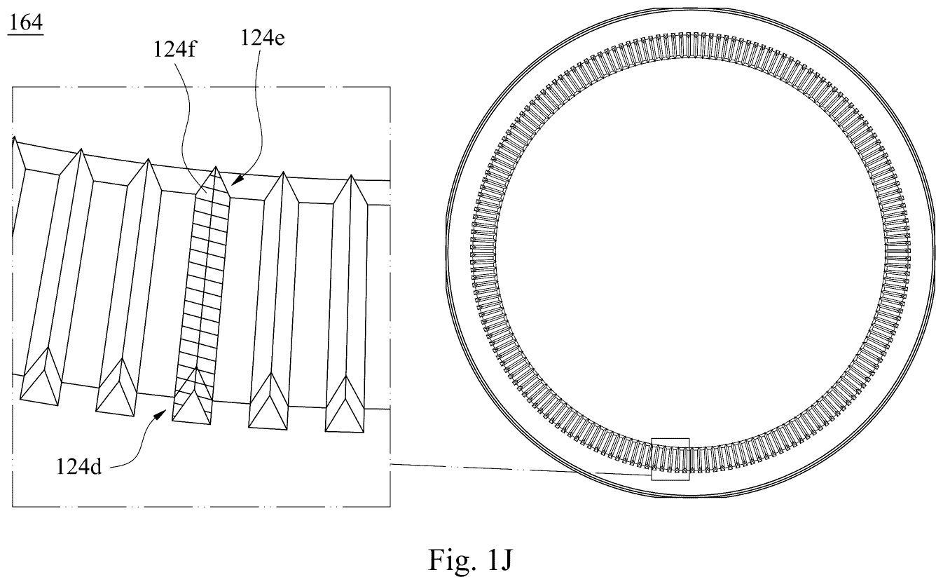

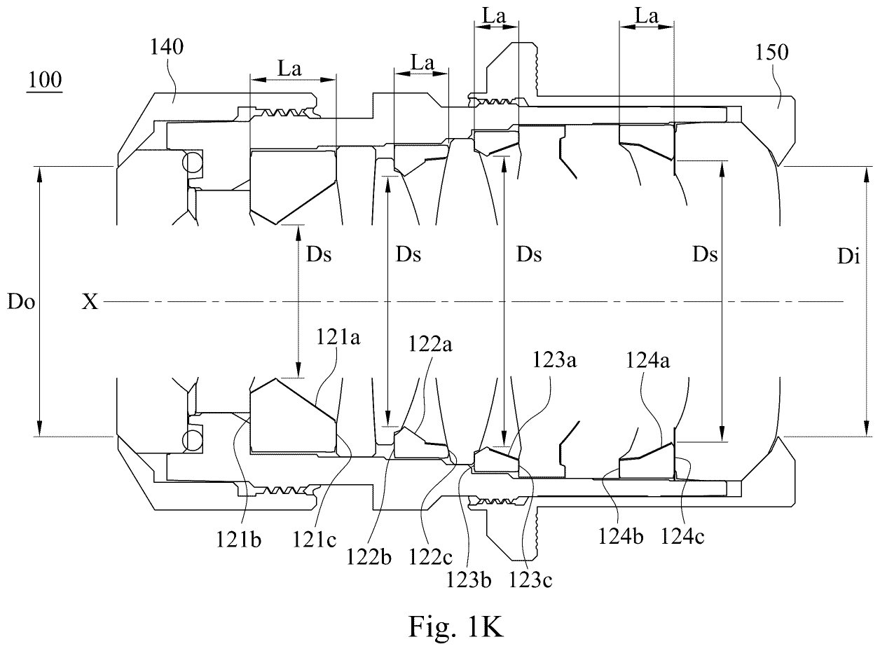

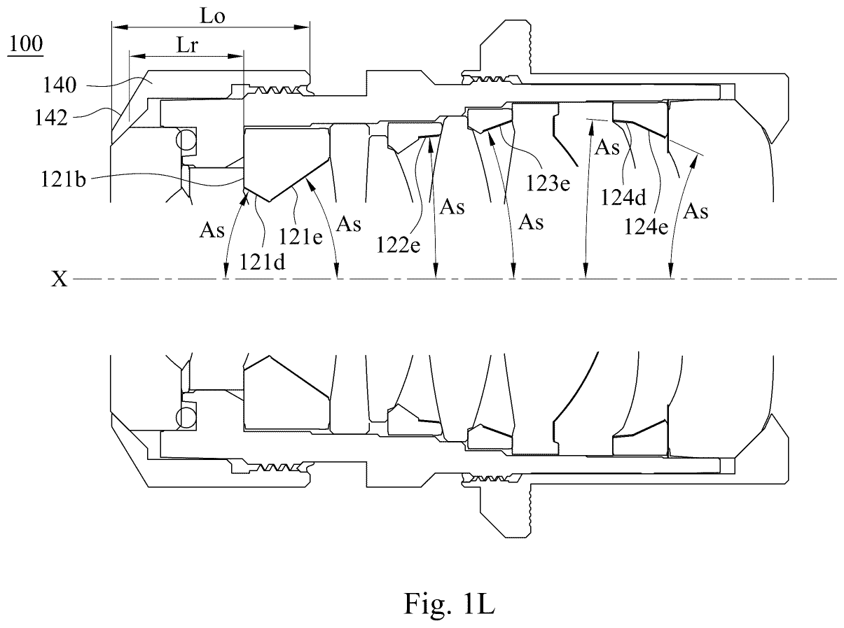

FIG. 1A is a three-dimensional view of an imaging lens assembly 100 according to the 1st Embodiment of the present disclosure, FIG. 1B is an exploded view of the imaging lens assembly 100 according to the 1st Embodiment in FIG. 1A, FIG. 1C is a schematic side view of the imaging lens assembly 100 according to the 1st Embodiment in FIG. 1A, and FIG. 1D is a cross-sectional view of the imaging lens assembly 100 along a cross line 1D-1D according to the 1st Embodiment in FIG. 1C. In FIG. 1A to FIG. 1D, the imaging lens assembly 100 has an optical axis X, and the imaging lens assembly 100 includes a plurality of lens elements 111, 112, 113, 114, 115, 116, 117, 118, a plurality of annular light blocking structures 121, 122, 123, 124, a plastic lens barrel 130, an object-side retainer 140 and an image-side retainer 150, wherein the lens elements 111, 112, 113, 114, 115, 116, 117, 118 are disposed in order along the optical axis X, and the lens elements 111, 112, 113, 114, 115, 116, 117, 118 and the annular light blocking structures 121, 122, 123, 124 are disposed in the plastic lens barrel 130.

Moreover, the imaging lens assembly 100 can further include a plurality of spacers 161, 162, 163, 164, a sealing member 165 and a plurality of spacer rings 166, 167. In FIG. 1B and FIG. 1D, the imaging lens assembly 100 includes the lens element 111, the sealing member 165, the spacer ring 166, the lens element 112, the spacer 161, the lens elements 113, 114, the spacer 162, the lens element 115, the spacer 163, the lens elements 116, 117, the spacer 164, the spacer ring 167, the lens element 118 arranged in order from an object side to an image side, wherein the number, the structure, the optical features of the surface shape of the lens elements and the other optical elements can be configured according to different imaging requirements, but not limited thereto.

Furthermore, a cemented lens group is composed of the lens element 116 and the lens element 117, the sealing member 165 can be an O-ring, and the sealing member 165 can be made of nitrile butadiene rubber (NBR), silicone (SI), fluororubber (FKM), ethylene propylene diene rubber (EPDM), polyurethane (PU) or perfluoroelastomer (FFKM), but not limited thereto.

The lens elements 111, 112, 113, 114, 115, 116, 117, 118 include an object-side lens element and an image-side lens element, wherein the lens element 111 is the object-side lens element, and the lens element 118 is the image-side lens element. In detail, the object-side lens element is the lens element in the lens elements 111, 112, 113, 114, 115, 116, 117, 118 most close to the object side, and the image-side lens element is the lens element in the lens elements 111, 112, 113, 114, 115, 116, 117, 118 most close to the image side.

In FIG. 1B, the object-side lens element (that is the lens element 111), the annular light blocking structures 121, 122, 123, 124 and the image-side lens element (that is the lens element 118) are disposed in order along the optical axis X from an object side of the imaging lens assembly 100 to an image side of the imaging lens assembly 100.

In FIG. 1D, the plastic lens barrel 130 includes an object-side portion 131, an image-side portion 132, an inner peripheral portion 133 and an outer peripheral portion 134. The object-side portion 131 faces towards the object side of the imaging lens assembly 100, and forms an object-side opening 131a. The image-side portion 132 faces towards the image side of the imaging lens assembly 100, and forms an image-side opening 132a. The inner peripheral portion 133 connects the object-side portion 131 and the image-side portion 132, and is disposed facing towards the optical axis X. The outer peripheral portion 134 connects the object-side portion 131 and the image-side portion 132, and is disposed corresponding to the inner peripheral portion 133 in the direction away from the optical axis X.

The object-side retainer 140 is disposed on the object-side portion 131 of the plastic lens barrel 130, and the object-side retainer 140 includes an object-side retaining portion 141 and an object-side abutting portion 142, wherein the object-side retaining portion 141 surrounds the outer peripheral portion 134 of the plastic lens barrel 130, the object-side abutting portion 142 extends from the object-side retaining portion 141 towards the optical axis X, and abuts the lens element 111 so as to fix the lens element 111 to the object-side portion 131 of the plastic lens barrel 130. The image-side retainer 150 is disposed on the image-side portion 132 of the plastic lens barrel 130 so as to fix the lens element 118 to the image-side portion 132 of the plastic lens barrel 130.

The lens elements 111, 112, 113, 114, 115, 116, 117, 118 are assembled through the object-side retainer 140 and the image-side retainer 150 with the design of the annular light blocking structures 121, 122, 123, 124 to provide the imaging lens assembly 100 assembled two-directionally so as to ensure the assembling feasibility of products and to provide the better optical quality. Moreover, the externally wrapped object-side retainer 140 can protect the structure of the imaging lens assembly 100 and improve the environmental tolerance of the imaging lens assembly 100 so as to extend the product service life. The design of the annular light blocking structures 121, 122, 123, 124 with the object-side retainer 140 is favorable for preventing the annular light blocking structures 121, 122, 123, 124 from the deformation due to the environmental temperature variation.

Specifically, the plastic lens barrel 130 has the corresponding thread structure so that the plastic lens barrel 130 can be assembled with the object-side retainer 140 and the image-side retainer 150, wherein the object-side retainer 140 is made of a metal material and has a thread structure so as to be correspondingly assembled with the plastic lens barrel 130. Moreover, a glue can also be disposed between the object-side retainer 140 and the plastic lens barrel 130. The image-side retainer 150 is made of a metal material and has a thread structure so as to be correspondingly assembled with the plastic lens barrel 130. Furthermore, a glue can also be disposed between the image-side retainer 150 and the plastic lens barrel 130.

FIG. 1E is a cross-sectional view of the imaging lens assembly 100 according to the 1st Embodiment in FIG. 1A, FIG. 1F is a partial enlarged view of the annular light blocking structure 121 disposed on the spacer 161 according to the 1st Embodiment in FIG. 1A, FIG. 1G is a three-dimensional view of the annular light blocking structure 122 disposed on the spacer 162 according to the 1st Embodiment in FIG. 1A, FIG. 1H is an enlarged schematic view of strip-shaped wedge structures 122e according to the 1st Embodiment in FIG. 1G, FIG. 1I is a three-dimensional view of the annular light blocking structure 124 disposed on the spacer 164 according to the 1st Embodiment in FIG. 1A. FIG. 1J is an enlarged schematic view of strip-shaped wedge structures 124d, 124e according to the 1st Embodiment in FIG. 1I, FIG. 1K is a schematic view of parameters of the imaging lens assembly 100 according to the 1st Embodiment in FIG. 1A, and FIG. 1L is another schematic view of parameters of the imaging lens assembly 100 according to the 1st Embodiment in FIG. 1A. In FIG. 1D to FIG. 1L, the annular light blocking structure 121 includes a light blocking surface 121a, an object-side surface 121b, an image-side surface 121c and a plurality of strip-shaped wedge structures 121d, 121e. The annular light blocking structure 122 includes a light blocking surface 122a, an object-side surface 122b, an image-side surface 122c and a plurality of strip-shaped wedge structures 122e. The annular light blocking structure 123 includes a light blocking surface 123a, an object-side surface 123b, an image-side surface 123c and a plurality of strip-shaped wedge structures 123e. The annular light blocking structure 124 includes a light blocking surface 124a, an object-side surface 124b, an image-side surface 124c and a plurality of strip-shaped wedge structures 124d, 124e.

In FIG. 1D, FIG. 1E, FIG. 1F, FIG. 1K and FIG. 1L, the light blocking surface 121a is disposed around and faces towards the optical axis X. The object-side surface 121b faces towards the object side of the imaging lens assembly 100, and extends from the light blocking surface 121a in a direction away from the optical axis X. The image-side surface 121c faces towards the image side of the imaging lens assembly 100, and extends from the light blocking surface 121a in the direction away from the optical axis X. The strip-shaped wedge structures 121d, 121e are disposed on the light blocking surface 121a, each of the strip-shaped wedge structures 121d, 121e extends from the object-side surface 121b to the image-side surface 121c, and the strip-shaped wedge structures 121d, 121e are arranged in a direction surrounding the optical axis X, wherein the strip-shaped wedge structures 121d, 121e are arranged in two sections. Moreover, the lens element 111 is placed into the plastic lens barrel 130 from the object-side opening 131a to the object-side surface 121b, and the lens element 118 is placed into the plastic lens barrel 130 from the image-side opening 132a to the image-side surface 121c.

In FIG. 1G, FIG. 1H, FIG. 1K and FIG. 1L, the light blocking surface 122a is disposed around and faces towards the optical axis X. The object-side surface 122b faces towards the object side of the imaging lens assembly 100, and extends from the light blocking surface 122a in a direction away from the optical axis X. The image-side surface 122c faces towards the image side of the imaging lens assembly 100, and extends from the light blocking surface 122a in the direction away from the optical axis X. The strip-shaped wedge structures 122e are disposed on the light blocking surface 122a, each of the strip-shaped wedge structures 122e extends from the object-side surface 122b to the image-side surface 122c, and the strip-shaped wedge structures 122e are arranged in a direction surrounding the optical axis X, wherein each of the strip-shaped wedge structures 122e includes a tapering portion 122f, and the tapering portion 122f tapers towards the optical axis X. Further, the strip-shaped wedge structures 122e can have round edges.

In FIG. 1K to FIG. 1L, the light blocking surface 123a is disposed around and faces towards the optical axis X. The object-side surface 123b faces towards the object side of the imaging lens assembly 100, and extends from the light blocking surface 123a in a direction away from the optical axis X. The image-side surface 123c faces towards the image side of the imaging lens assembly 100, and extends from the light blocking surface 123a in the direction away from the optical axis X. The strip-shaped wedge structures 123e are disposed on the light blocking surface 123a, each of the strip-shaped wedge structures 123e extends from the object-side surface 123b to the image-side surface 123c, and the strip-shaped wedge structures 123e are arranged in a direction surrounding the optical axis X.

In FIG. 1I to FIG. 1L, the light blocking surface 124a is disposed around and faces towards the optical axis X. The object-side surface 124b faces towards the object side of the imaging lens assembly 100, and extends from the light blocking surface 124a in a direction away from the optical axis X. The image-side surface 124c faces towards the image side of the imaging lens assembly 100, and extends from the light blocking surface 124a in the direction away from the optical axis X. The strip-shaped wedge structures 124d, 124e are disposed on the light blocking surface 124a, each of the strip-shaped wedge structures 124d, 124e extends from the object-side surface 124b to the image-side surface 124c, and the strip-shaped wedge structures 124d, 124e are arranged in a direction surrounding the optical axis X, wherein each of the strip-shaped wedge structures 124d, 124e includes a tapering portion 124f, and the tapering portion 124f tapers towards the optical axis X. Furthermore, a bend may be formed between the strip-shaped wedge structures 124d and the strip-shaped wedge structures 124e, the strip-shaped wedge structures 124d, 124e have sharp edges, and the strip-shaped wedge structures 124d, 124e may not be connected to each other.

The interference of the stray light can be reduced and the better image recognizing ability can be provided in an environment with strong sunlight or in a dark night environment through the design of the strip-shaped wedge structures 121d, 121e, 122e, 123e, 124d, 124e.

The lens element 111 can be made of a glass material, and the lens element 118 can be made of a plastic material, but not limited thereto. Specifically, the imaging lens assembly 100 composed by a glass lens element and a plastic lens element can be taken account of the temperature effect and can satisfy the microminiaturization requirement.

In FIG. 1E, the object-side abutting portion 142 of the object-side retainer 140 can have a first alignment structure 143, and the lens element 111 can have a second alignment structure 111b, wherein the first alignment structure 143 and the second alignment structure 111b rely to each other so as to align the lens element 111 to the optical axis X of the imaging lens assembly 100. Therefore, it is favorable for simplifying the assembling process.

In FIG. 1B to FIG. 1D, the annular light blocking structure 121 can be disposed on a spacer 161, the annular light blocking structure 122 can be disposed on a spacer 162, the annular light blocking structure 123 can be disposed on a spacer 163, and the annular light blocking structure 124 can be disposed on a spacer 164, wherein the spacer 161 is disposed between the lens elements 112, 113, the spacer 162 is disposed between the lens elements 114, 115, the spacer 163 is disposed between the lens elements 115, 116, and the spacer 164 is disposed between the lens elements 117, 118. Therefore, the stray light can be reduced through disposing the annular light blocking structures 121, 122, 123, 124 so as to improve the optical imaging quality.

In FIG. 1D, the image-side retainer 150 can include an image-side retaining portion 151 and an image-side abutting portion 152, wherein the image-side retaining portion 151 surrounds the outer peripheral portion 134 of the plastic lens barrel 130, and the image-side abutting portion 152 extends from the image-side retaining portion 151 towards the optical axis X and abuts the lens element 118. The overall structure of the imaging lens assembly 100 can be protected through the externally wrapped image-side retainer 150, and the environmental tolerance of the imaging lens assembly 100 can be improved so as to extend the product service life.

In FIG. 1K and FIG. 1L, when a minimum diameter of the object-side retainer 140 is Do, a minimum diameter of the image-side retainer 150 is Di, a minimum diameter of the light blocking surfaces 121a, 122a, 123a, 124a is Ds, a distance between the object-side surfaces 121b, 122b, 123b, 124b and the image-side surfaces 121c, 122c, 123c, 124c in a direction parallel to the optical axis X is La, an angle formed between each of the strip-shaped wedge structures 121d, 121e, 122e, 123e, 124d, 124e and the optical axis X is As, a distance between the object-side abutting portion 142 of the object-side retainer 140 and the object-side surface 121b of the annular light blocking structure 121 in a direction parallel to the optical axis X is Lr, and a length of the object-side retainer 140 in the direction parallel to the optical axis X is Lo, the mentioned parameters satisfy the following conditions in Table 1.

TABLE 1
1st Embodiment

| | | | |
|---|---|---|---|
| Do (mm) | 10.70 | La (mm) | 2.17 |
| | | (object-side surface 124b and | |
| | | image-side surface 124c) | |
| Di (mm) | 10.70 | La/Ds | 0.56 |
| | | (light blocking surface 121a/ | |
| | | object-side surface 121b and | |
| | | image-side surface 121c) | |
| Ds (mm) | 6.07 | La/Ds | 0.22 |
| (light blocking surface | | (light blocking surface 122a/ | |
| 121a) | | object-side surface 122b and | |
| | | image-side surface 122c) | |
| Ds (mm) | 9.90 | La/Ds | 0.15 |
| (light blocking surface | | (light blocking surface 123a/ | |
| 122a) | | object-side surface 123b and | |
| | | image-side surface 123c) | |
| Ds (mm) | 11.50 | La/Ds | 0.19 |
| (light blocking surface | | (light blocking surface 124a/ | |
| 123a) | | object-side surface 124b and | |
| | | image-side surface 124c) | |
| Ds (mm) | 11.13 | As (degree) | 30 |
| (light blocking surface | | (strip-shaped wedge structure | |
| 124a) | | 121d) | |
| Ds/(Do + Di) | 0.28 | As (degree) | 35 |
| (light blocking surface | | (strip-shaped wedge structure | |
| 121a) | | 121e) | |
| Ds/(Do + Di) | 0.46 | As (degree) | 5 |
| (light blocking surface | | (strip-shaped wedge structure | |
| 122a) | | 122e) | |
| Ds/(Do + Di) | 0.54 | As (degree) | 20 |
| (light blocking surface | | (strip-shaped wedge structure | |
| 123a) | | 123e) | |
| Ds/(Do + Di) | 0.52 | As (degree) | 5 |
| (light blocking surface | | (strip-shaped wedge structure | |
| 124a) | | 124d) | |
| \|Do − Di\| (mm) | 0 | As (degree) | 25 |
| | | (strip-shaped wedge structure | |
| | | 124e) | |
| La (mm) | 3.41 | Lr (mm) | 4.53 |
| (object-side surface 121b | | | |
| and image-side surface | | | |
| 121c) | | | |
| La (mm) | 2.16 | Lo (mm) | 7.85 |
| (object-side surface 122b | | | |
| and image-side surface | | | |
| 122c) | | | |
| La (mm) | 1.76 | Lr/Lo | 0.58 |
| (object-side surface 123b | | | |
| and image-side surface | | | |
| 123c) | | | |

It should be noted that part of the structures of the lens elements 111, 112, 113, 114, 115, 116, 117, 118 in FIG. 1K and FIG. 1L are omitted.

### 2nd Embodiment

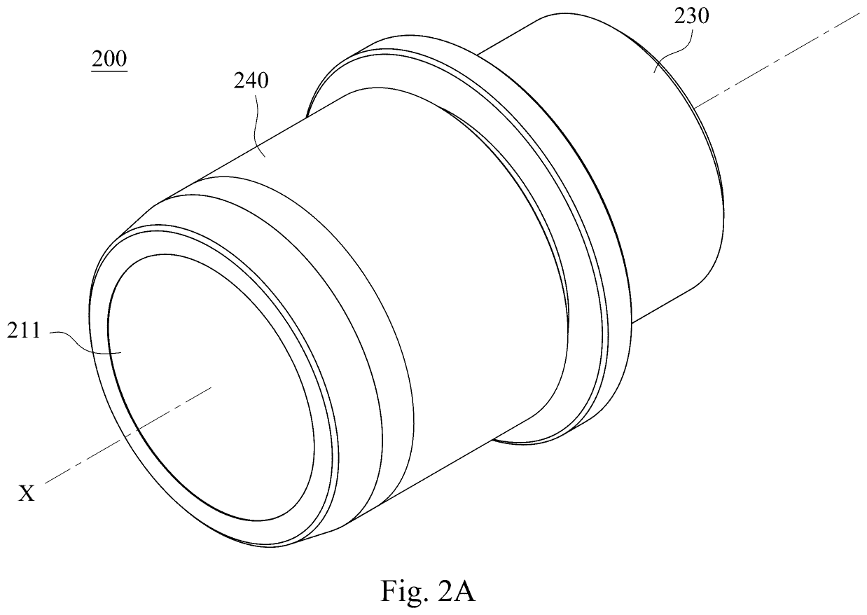

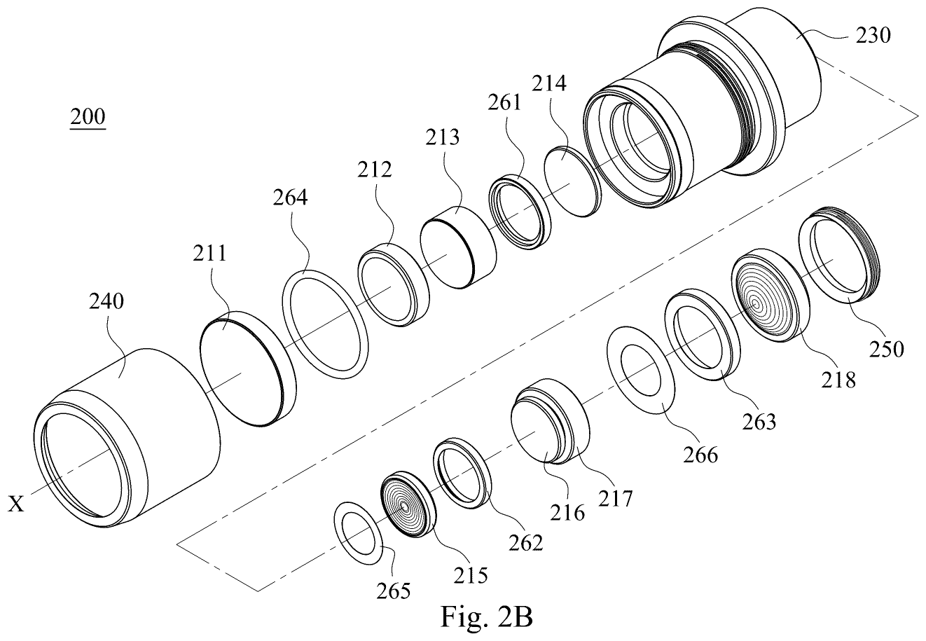

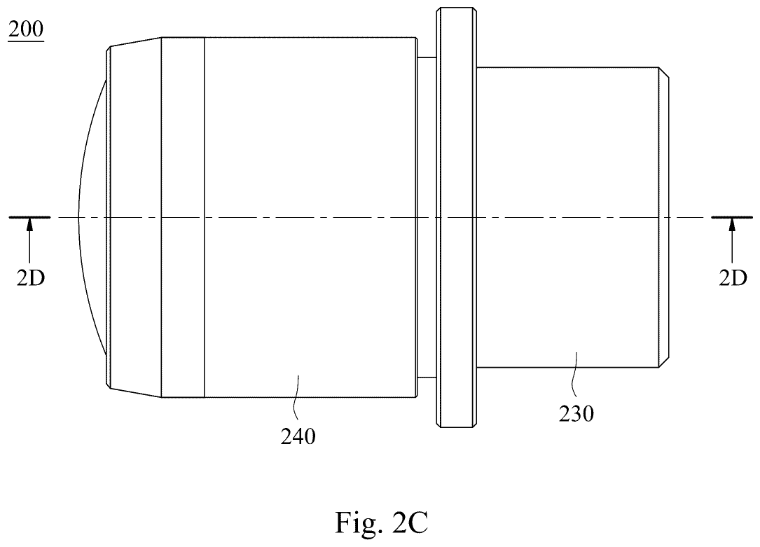

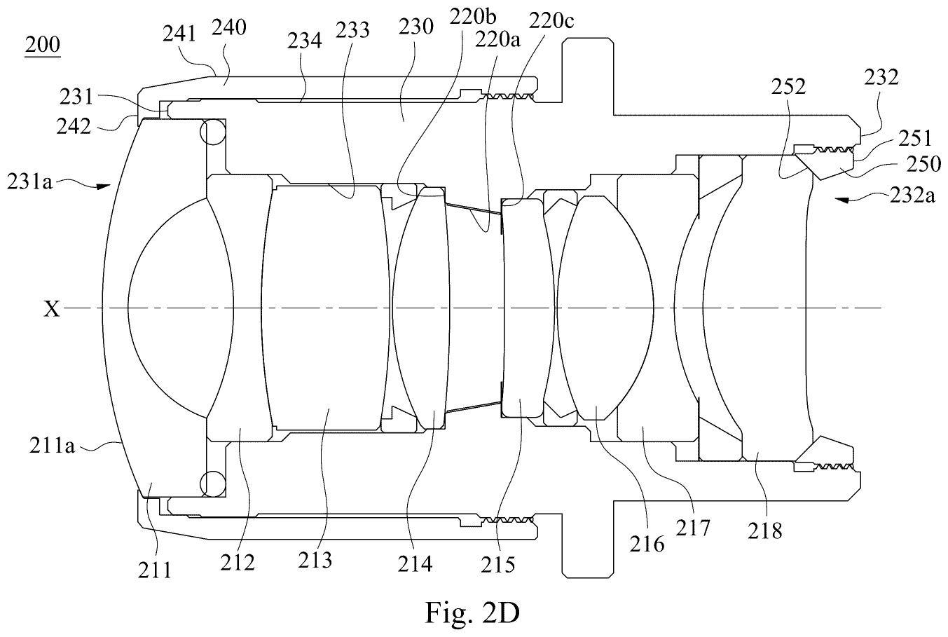

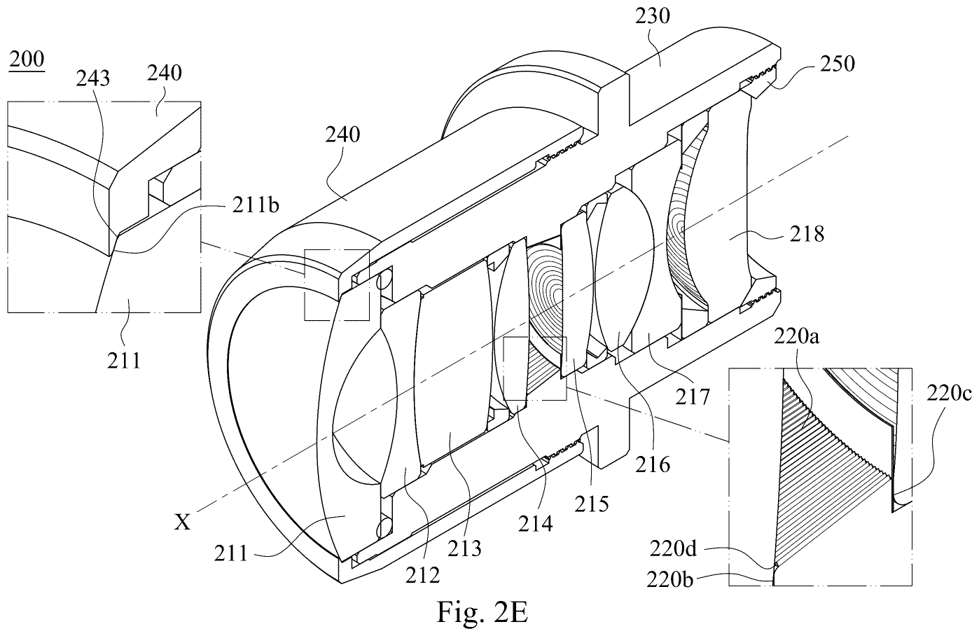

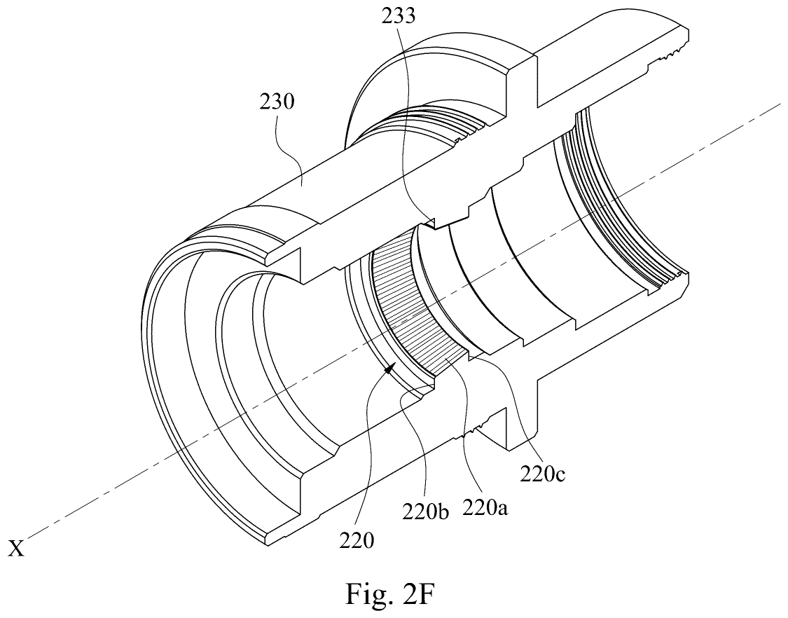

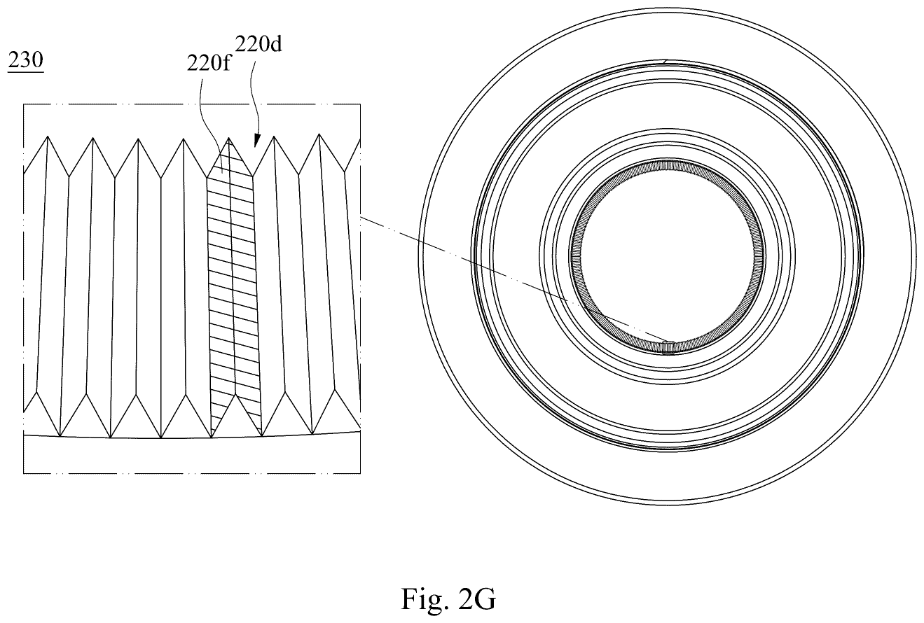

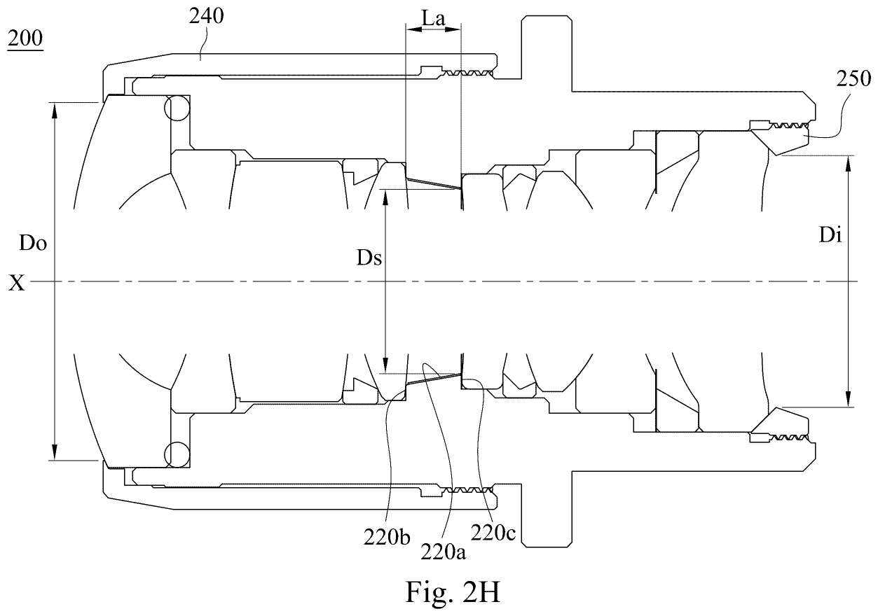

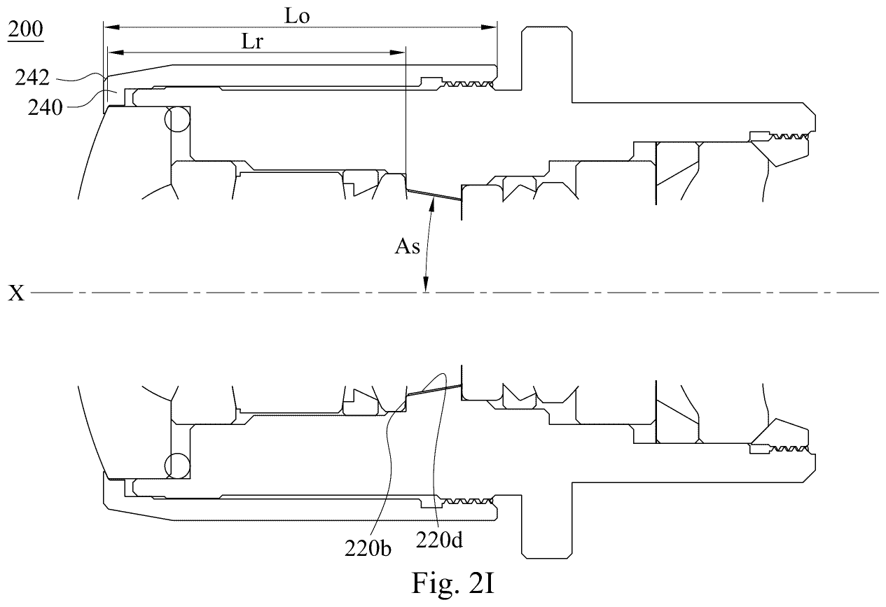

FIG. 2A is a three-dimensional view of an imaging lens assembly 200 according to the 2nd Embodiment of the present disclosure, FIG. 2B is an exploded view of the imaging lens assembly 200 according to the 2nd Embodiment in FIG. 2A, FIG. 2C is a schematic side view of the imaging lens assembly 200 according to the 2nd Embodiment in FIG. 2A, FIG. 2D is a cross-sectional view of the imaging lens assembly 200 along a cross line 2D-2D according to the 2nd Embodiment in FIG. 2C, FIG. 2E is a cross-sectional view of the imaging lens assembly 200 according to the 2nd Embodiment in FIG. 2A, and FIG. 2F is a three-dimensional view of an annular light blocking structure 220 disposed on an inner peripheral portion 233 of a plastic lens barrel 230 according to the 2nd Embodiment in FIG. 2A. In FIG. 2A to FIG. 2F, the imaging lens assembly 200 has an optical axis X, and the imaging lens assembly 200 includes a plurality of lens elements 211, 212, 213, 214, 215, 216, 217, 218, an annular light blocking structure 220, a plastic lens barrel 230, an object-side retainer 240 and an image-side retainer 250, wherein the lens elements 211, 212, 213, 214, 215, 216, 217, 218 are disposed in order along the optical axis X, and the lens elements 211, 212, 213, 214, 215, 216, 217, 218 and the annular light blocking structure 220 are disposed in the plastic lens barrel 230.

Moreover, the imaging lens assembly 200 can further include a plurality of spacers 261, 262, 263, a sealing member 264 and a plurality of spacer rings 265, 266. In FIG. 2B and FIG. 2D, the imaging lens assembly 200 includes the lens element 211, the sealing member 264, the lens element 212, the lens element 213, the spacer 261, the lens element 214, the spacer ring 265, the lens element 215, the spacer 262, the lens elements 216, 217, the spacer ring 266, the spacer 263, the lens element 218 arranged in order from an object side to an image side, wherein the number, the structure, the optical features of the surface shape of the lens elements and the other optical elements can be configured according to different imaging requirements, but not limited thereto.

Furthermore, a cemented lens group is composed of the lens element 216 and the lens element 217, the sealing member 264 can be an O-ring, and the sealing member 264 can be made of NBR, SI, FKM, EPDM, PU or FFKM, but not limited thereto.

The lens elements 211, 212, 213, 214, 215, 216, 217, 218 include an object-side lens element and an image-side lens element, wherein the lens element 211 is the object-side lens element, and the lens element 218 is the image-side lens element. In detail, the object-side lens element is the lens element in the lens elements 211, 212, 213, 214, 215, 216, 217, 218 most close to the object side, and the image-side lens element is the lens element in the lens elements 211, 212, 213, 214, 215, 216, 217, 218 most close to the image side.

Furthermore, the object-side lens element (that is the lens element 211), the annular light blocking structure 220 and the image-side lens element (that is the lens element 218) are disposed in order along the optical axis X from an object side of the imaging lens assembly 200 to an image side of the imaging lens assembly 200.

In FIG. 2D, the plastic lens barrel 230 includes an object-side portion 231, an image-side portion 232, an inner peripheral portion 233 and an outer peripheral portion 234. The object-side portion 231 faces towards the object side of the imaging lens assembly 200 and forms an object-side opening 231a. The image-side portion 232 faces towards the image side of the imaging lens assembly 200 and forms an image-side opening 232a. The inner peripheral portion 233 connects the object-side portion 231 and the image-side portion 232, and is disposed facing towards the optical axis X. The outer peripheral portion 234 connects the object-side portion 231 and the image-side portion 232, and is disposed corresponding to the inner peripheral portion 233 in the direction away from the optical axis X.

The object-side retainer 240 is disposed on the object-side portion 231 of the plastic lens barrel 230, and the object-side retainer 240 includes an object-side retaining portion 241 and an object-side abutting portion 242, wherein the object-side retaining portion 241 surrounds the outer peripheral portion 234 of the plastic lens barrel 230, the object-side abutting portion 242 extends from the object-side retaining portion 241 towards the optical axis X, and abuts the lens element 211 so as to fix the lens element 211 to the object-side portion 231 of the plastic lens barrel 230. The image-side retainer 250 is disposed on the image-side portion 232 of the plastic lens barrel 230 so as to fix the lens element 218 to the image-side portion 232 of the plastic lens barrel 230.

Specifically, the plastic lens barrel 230 has the corresponding thread structure so that the plastic lens barrel 230 can be assembled with the object-side retainer 240 and the image-side retainer 250, wherein the object-side retainer 240 is made of a metal material and has a thread structure so as to be correspondingly assembled with the plastic lens barrel 230. Moreover, a glue can also be disposed between the object-side retainer 240 and the plastic lens barrel 230. The image-side retainer 250 is made of a plastic material and has a thread structure so as to be correspondingly assembled with the plastic lens barrel 230. Furthermore, a glue can also be disposed between the image-side retainer 250 and the plastic lens barrel 230.

FIG. 2G is an enlarged schematic view of strip-shaped wedge structures 220d according to the 2nd Embodiment in FIG. 2F, FIG. 2H is a schematic view of parameters of the imaging lens assembly 200 according to the 2nd Embodiment in FIG. 2A, and FIG. 2I is another schematic view of parameters of the imaging lens assembly 200 according to the 2nd Embodiment in FIG. 2A. In FIG. 2D to FIG. 2I, the annular light blocking structure 220 includes a light blocking surface 220a, an object-side surface 220b, an image-side surface 220c and a plurality of strip-shaped wedge structures 220d.

The light blocking surface 220a is disposed around and faces towards the optical axis X. The object-side surface 220b faces towards the object side of the imaging lens assembly 200, and extends from the light blocking surface 220a in a direction away from the optical axis X. The image-side surface 220c faces towards the image side of the imaging lens assembly 200, and extends from the light blocking surface 220a in the direction away from the optical axis X. The strip-shaped wedge structures 220d are disposed on the light blocking surface 220a, each of the strip-shaped wedge structures 220d extends from the object-side surface 220b to the image-side surface 220c, and the strip-shaped wedge structures 220d are arranged in a direction surrounding the optical axis X, wherein each of the strip-shaped wedge structures 220d includes a tapering portion 220f, and the tapering portion 220f tapers towards the optical axis X. Moreover, the lens element 211 is placed into the plastic lens barrel 230 from the object-side opening 231a to the object-side surface 220b, and the lens element 218 is placed into the plastic lens barrel 230 from the image-side opening 232a to the image-side surface 220c.

In FIG. 2D, the lens element 211 can include a convex surface 211a, wherein the convex surface 211a faces towards the object side of the imaging lens assembly 200. Therefore, the better light collecting effect can be provided, and it is favorable for improving the image recognizing ability.

In FIG. 2E, the object-side abutting portion 242 of the object-side retainer 240 can have a first alignment structure 243, and the lens element 211 can have a second alignment structure 211b, wherein the first alignment structure 243 and the second alignment structure 211b rely to each other so as to align the lens element 211 to the optical axis X of the imaging lens assembly 200.

In FIG. 2F, the annular light blocking structure 220 is disposed on the inner peripheral portion 233 of the plastic lens barrel 230, and the annular light blocking structure 220 on the inner peripheral portion 233 extends from the inner peripheral portion 233 to the optical axis X. Therefore, the stray light can be reduced through disposing the annular light blocking structure 220 so as to improve the optical imaging quality.

In FIG. 2D, the image-side retainer 250 can include an image-side retaining portion 251 and an image-side abutting portion 252, wherein the image-side abutting portion 252 extends from the image-side retaining portion 251 towards the optical axis X and abuts the lens element 218.

In FIG. 2H and FIG. 2I, when a minimum diameter of the object-side retainer 240 is Do, a minimum diameter of the image-side retainer 250 is Di, a minimum diameter of the light blocking surface 220a is Ds, a distance between the object-side surface 220b and the image-side surfaces 220c in a direction parallel to the optical axis X is La, an angle formed between each of the strip-shaped wedge structures 220d and the optical axis X is As, a distance between the object-side abutting portion 242 of the object-side retainer 240 and the object-side surface 220b of the annular light blocking structure 220 in a direction parallel to the optical axis X is Lr, and a length of the object-side retainer 240 in the direction parallel to the optical axis X is Lo, the mentioned parameters satisfy the following conditions in Table 2.

TABLE 2
2nd Embodiment

| | | | |
|---|---|---|---|
| Do (mm) | 14.15 | La/Ds | 0.30 |
| Di (mm) | 9.95 | As (degree) | 10 |
| Ds (mm) | 7.29 | Lr (mm) | 11.78 |
| Ds/(Do + Di) | 0.30 | Lo (mm) | 15.55 |
| \|Do − Di\| (mm) | 4.20 | Lr/Lo | 0.76 |
| La (mm) | 2.19 | | |

It should be noted that part of the structures of the lens elements 211, 212, 213, 214, 215, 216, 217, 218 in FIG. 2H and FIG. 2I are omitted.

### 3rd Embodiment

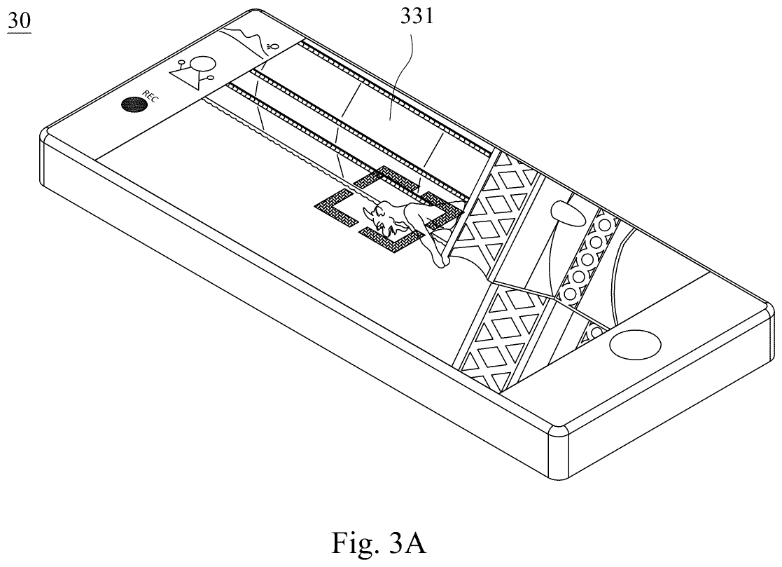

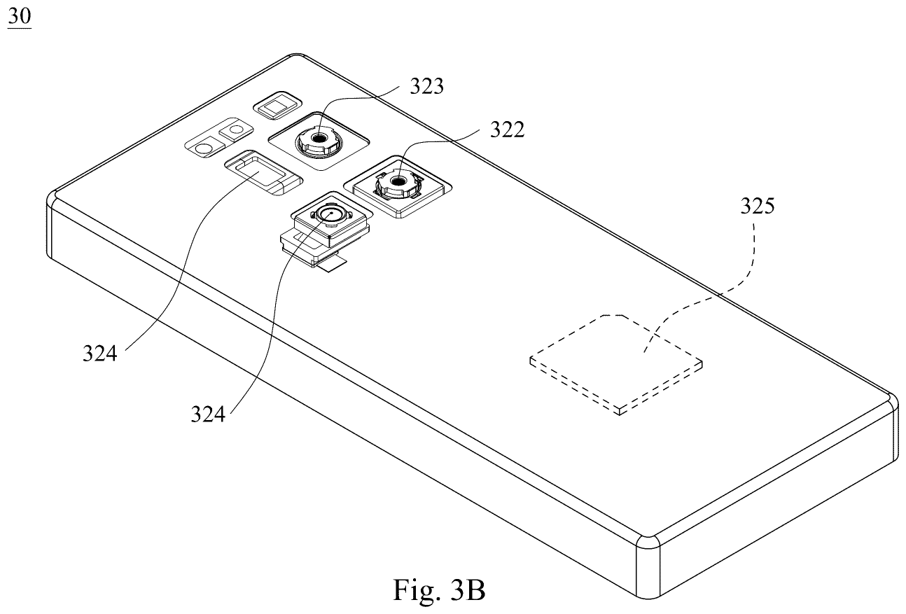

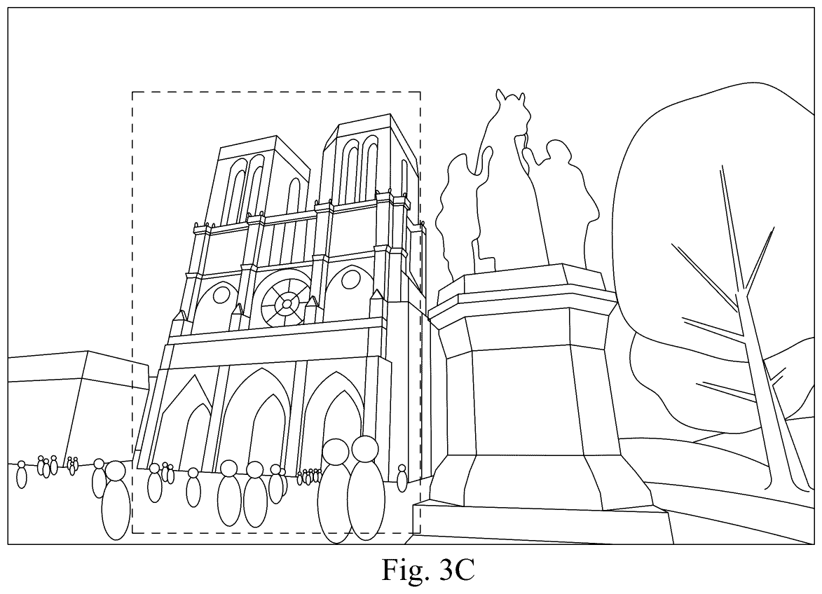

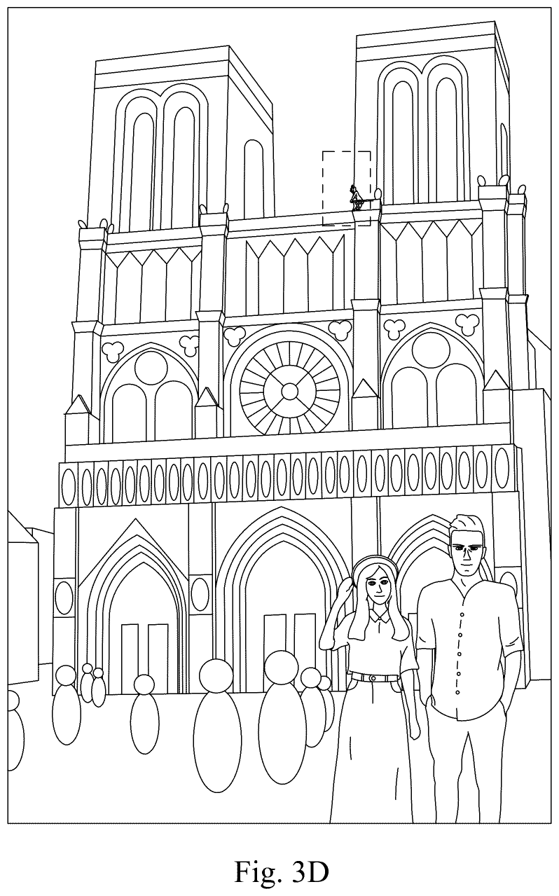

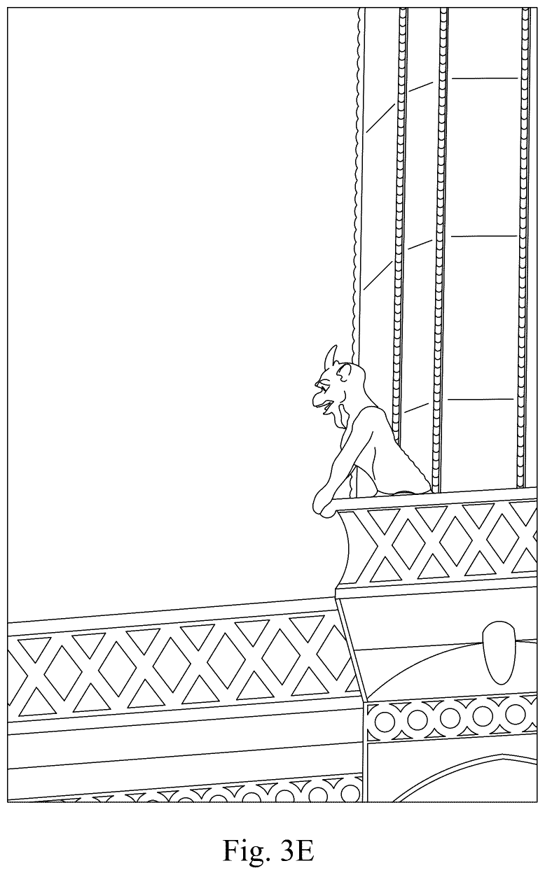

FIG. 3A is a schematic view of an electronic device 30 according to the 3rd Embodiment of the present disclosure, and FIG. 3B is another schematic view of the electronic device 30 according to the 3rd Embodiment in FIG. 3A. In FIG. 3A and FIG. 3B, the electronic device 30 is a smart phone, and the electronic device 30 includes camera modules and a user interface 331, and each of the camera modules includes an imaging lens assembly. Moreover, the camera modules are an ultra-wide angle camera module 322, a high resolution camera module 323 and a telephoto camera module 324, and the user interface 331 is a touch screen, but the present disclosure is not limited thereto. Particularly, the imaging lens assembly can be the imaging lens assembly according to any one of the aforementioned 1st Embodiment to the 2nd Embodiment, but the present disclosure is not limited thereto.

A user enters a shooting mode via the user interface 331, wherein the user interface 331 is configured to display an image, and the shooting angle can be manually adjusted to switch to different camera modules. At this moment, the imaging light is gathered on an image sensor of the electronic device 30, and an electronic signal about an image is output to an image signal processor (ISP) 325.

In FIG. 3B, in order to meet a camera specification of the electronic device 30, the electronic device 30 can further include an optical anti-shake mechanism (not shown). Furthermore, the electronic device 30 can further include at least one focusing assisting module (not shown) and at least one sensing element (not shown). The focusing assisting module can be a flash module (not shown) for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the camera module of the electronic device 30 equipped with an auto-focusing mechanism and the optical anti-shake mechanism can be enhanced to achieve the superior image quality. Furthermore, the electronic device 30 according to the present disclosure can have a capturing function with multiple modes, such as taking optimized selfies, high dynamic range (HDR) under a low light condition, 4K resolution recording and so on. Furthermore, the user can visually see a captured image of the camera via the user interface 331 and manually operate the view finding range on the user interface 331 to achieve the autofocus function of what you see is what you get.

Moreover, the camera module, the optical anti-shake mechanism, the sensing element and the focusing assisting module can be disposed on a flexible printed circuit board (FPC) (not shown) and electrically connected to the image signal processor 325 and other related components, via a connector (not shown) to perform a capturing process. Since the current electronic devices, such as smart phones, have a tendency of being compact, the way of firstly disposing the camera module and related components on the flexible printed circuit board and secondly integrating the circuit thereof into the main board of the electronic device via the connector can satisfy the requirements of the mechanical design and the circuit layout of the limited space inside the electronic device, and obtain more margins. The autofocus function of the imaging lens assembly can also be controlled more flexibly via the touch screen of the electronic device. According to the 3rd Embodiment, the electronic device 30 can include a plurality of sensing elements and a plurality of focusing assisting modules. The sensing elements and the focusing assisting modules are disposed on the flexible printed circuit board and at least one other flexible printed circuit board (not shown) and electrically connected to the image signal processor 325 and other related components, via corresponding connectors to perform the capturing process. In other embodiments (not shown), the sensing elements and the focusing assisting modules can also be disposed on the main board of the electronic device or carrier boards of other types according to requirements of the mechanical design and the circuit layout.

Furthermore, the electronic device 30 can further include, but not be limited to, a display, a control unit, a storage unit, a random access memory (RAM), a read-only memory (ROM), or the combination thereof.

FIG. 3C is a schematic view of an image captured via the electronic device 30 according to the 3rd Embodiment in FIG. 3A. In FIG. 3C, the larger range of the image can be captured via the ultra-wide angle camera module 322, and the ultra-wide angle camera module 322 has the function of accommodating wider range of the scene.

FIG. 3D is a schematic view of another image captured via the electronic device 30 according to the 3rd Embodiment in FIG. 3A. In FIG. 3D, the image of the certain range with the high resolution can be captured via the high resolution camera module 323, and the high resolution camera module 323 has the function of the high resolution and the low deformation.

FIG. 3E is a schematic view of another image captured via the electronic device 30 according to the 3rd Embodiment in FIG. 3A. In FIG. 3E, the telephoto camera module 324 has the enlarging function of the high magnification, and the distant image can be captured and enlarged with high magnification via the telephoto camera module 324.

In FIG. 3C to FIG. 3E, the zooming function can be obtained via the electronic device 30, when the scene is captured via the camera modules with different focal lengths cooperated with the function of image processing.

### 4th Embodiment

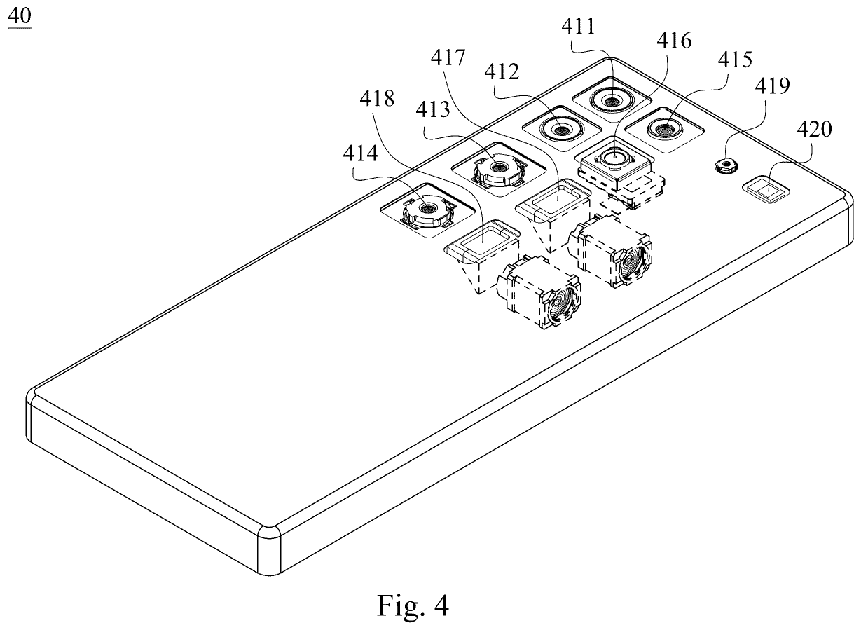

FIG. 4 is a schematic view of an electronic device 40 according to the 4th Embodiment of the present disclosure. In FIG. 4, the electronic device 40 is a smart phone, the electronic device 40 includes camera modules, and each of the camera modules includes an imaging lens assembly. Moreover, the camera modules are ultra-wide angle camera modules 411, 412, wide angle camera modules 413, 414, telephoto camera modules 415, 416, 417, 418 and a Time-Of-Flight (TOF) module 419. The TOF module 419 can be another type of the camera module, and the disposition is not limited thereto. Particularly, the imaging lens assembly can be the imaging lens assembly according to any one of the aforementioned 1st Embodiment to the 2nd Embodiment, but the present disclosure is not limited thereto.

Furthermore, the telephoto camera modules 417, 418 are configured to fold the light, but the present disclosure is not limited thereto.

To meet a specification of the camera module of the electronic device 40, the electronic device 40 can further include an optical anti-shake mechanism (not shown). Furthermore, the electronic device 40 can further include at least one focusing assisting module (not shown) and at least one sensing element (not shown). The focusing assisting module can be a flash module 420 for compensating a color temperature, an infrared distance measurement component, a laser focus module and so on. The sensing element can have functions for sensing physical momentum and kinetic energy, such as an accelerator, a gyroscope, a Hall Effect Element, to sense shaking or jitters applied by hands of the users or external environments. Accordingly, the camera module of the electronic device 40 equipped with an auto-focusing mechanism and the optical anti-shake mechanism can be enhanced to achieve the superior image quality. Furthermore, the electronic device 40 according to the present disclosure can have a capturing function with multiple modes, such as taking optimized selfies, High Dynamic Range (HDR) under a low light condition, 4K Resolution recording and so on.

Moreover, all of other component structures and dispositions according to the 4th Embodiment are the same as the component structures and the dispositions according to the 3rd Embodiment, and will not be described again herein.

### 5th Embodiment

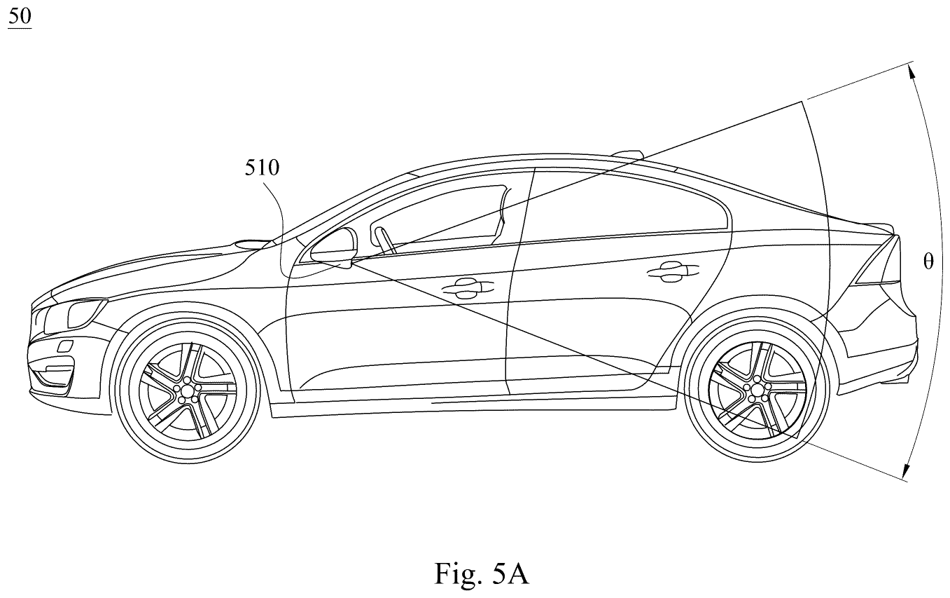

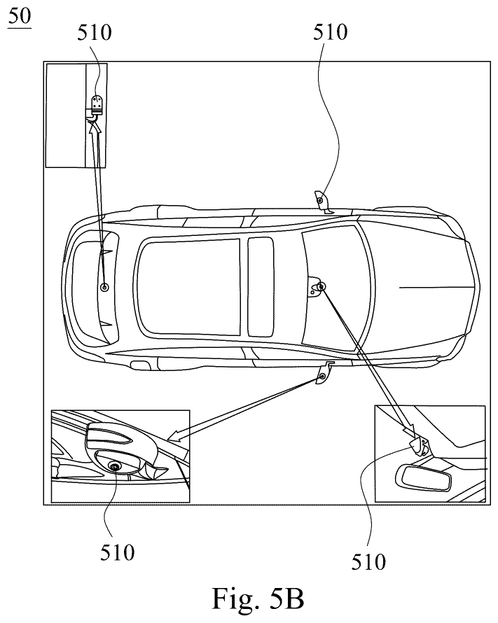

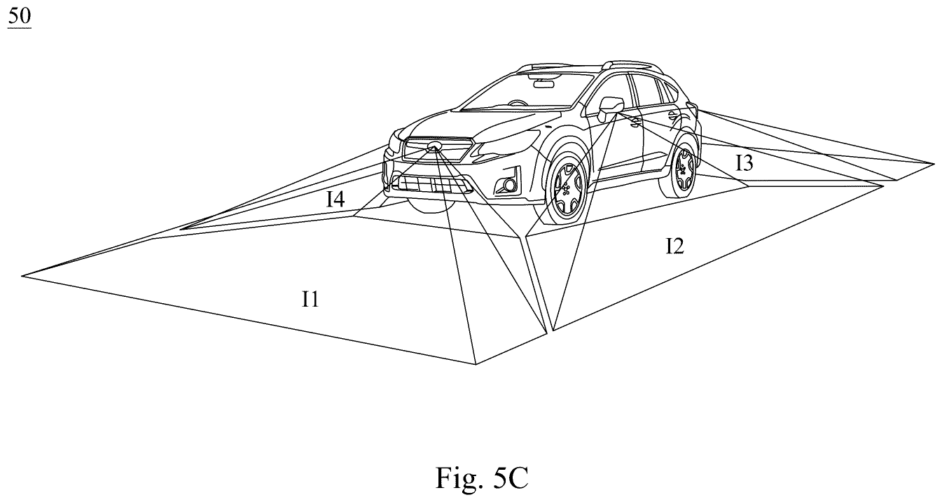

FIG. 5A is a schematic view of a mobile transportation 50 according to the 5th Embodiment of the present disclosure, FIG. 5B is another schematic view of the mobile transportation 50 according to the 5th Embodiment in FIG. 5A, and FIG. 5C is another schematic view of the mobile transportation 50 according to the 5th Embodiment in FIG. 5A. In FIG. 5A to FIG. 5C, the mobile transportation 50 includes camera modules 510, and each of the camera modules 510 includes an imaging lens assembly. In the 5th Embodiment, a number of the camera modules 510 is six, the camera modules 510 are vehicle camera modules, and the structures of the imaging lens assembly can be the imaging lens assembly according to any one of the aforementioned 1st Embodiment to the 2nd Embodiment, but the present disclosure is not limited thereto.

In FIG. 5A to FIG. 5B, two of camera modules 510 are disposed below a left rearview mirror and a right rearview mirror, respectively, to capture the image information with a visual angle θ. Particularly, the visual angle θ can satisfy the following condition 40 degrees<θ<90 degrees. Therefore, the image information within a left lane and a right lane can be captured.

In FIG. 5B, another two of the camera modules 510 can be disposed in an inner space of the mobile transportation 50. Particularly, the another two of camera modules 510 are disposed near a rearview mirror and near a rear window in the mobile transportation 50 respectively. Moreover, the camera modules 510 can be disposed on the non-mirror surfaces of the left rearview mirror and the right rearview mirror of the mobile transportation 50, respectively, but the present disclosure is not limited thereto.

In FIG. 5C, the other two of the camera modules 510 can be disposed at a front-end and a rear-end of the mobile transportation 50, respectively, wherein the camera modules 510 are disposed at a front-end and a rear-end of the mobile transportation 50, and below the left rearview mirror and the right rearview mirror. It is favorable to a driver to obtain the information of the outer space, such as external space informations I1, I2, I3, I4, but the present disclosure is not limited thereto. Therefore, more visual angles can be provided to reduce the blind spot, so that the driving safety can be improved. Moreover, it is helpful to identify the traffic information out of the mobile transportation 50 via disposing the camera modules 510 around the mobile transportation 50, which is favorable for realizing a function of autopilot driving.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens assembly having an optical axis, and comprising:
a plurality of lens elements disposed in order along the optical axis, wherein the lens elements comprise an object-side lens element and an image-side lens element;
an annular light blocking structure, wherein the object-side lens element, the annular light blocking structure and the image-side lens element are disposed in order along the optical axis from an object side of the imaging lens assembly to an image side of the imaging lens assembly, and the annular light blocking structure comprises:
a light blocking surface disposed around and facing towards the optical axis;
an object-side surface facing towards the object side of the imaging lens assembly, and extending from the light blocking surface in a direction away from the optical axis;
an image-side surface facing towards the image side of the imaging lens assembly, and extending from the light blocking surface in the direction away from the optical axis; and
a plurality of strip-shaped wedge structures disposed on the light blocking surface, wherein each of the strip-shaped wedge structures extends from the object-side surface to the image-side surface, the strip-shaped wedge structures are arranged in a direction surrounding the optical axis, each of the strip-shaped wedge structures comprises a tapering portion, and the tapering portion tapers towards the optical axis;
a plastic lens barrel, wherein the lens elements and the annular light blocking structure are disposed in the plastic lens barrel, and the plastic lens barrel comprises:
an object-side portion facing towards the object side of the imaging lens assembly and forming an object-side opening, wherein the object-side lens element is placed into the plastic lens barrel from the object-side opening to the object-side surface;
an image-side portion facing towards the image side of the imaging lens assembly and forming an image-side opening, wherein the image-side lens element is placed into the plastic lens barrel from the image-side opening to the image-side surface;
an inner peripheral portion connecting the object-side portion and the image-side portion, and disposed facing towards the optical axis; and
an outer peripheral portion connecting the object-side portion and the image-side portion, and disposed corresponding to the inner peripheral portion in the direction away from the optical axis;
an object-side retainer disposed on the object-side portion of the plastic lens barrel, and comprising:
an object-side retaining portion surrounding the outer peripheral portion of the plastic lens barrel; and
an object-side abutting portion extending from the object-side retaining portion towards the optical axis, and abutting the object-side lens element so as to fix the object-side lens element to the object-side portion of the plastic lens barrel; and
an image-side retainer disposed on the image-side portion of the plastic lens barrel so as to fix the image-side lens element to the image-side portion of the plastic lens barrel;
wherein a minimum diameter of the object-side retainer is Do, a minimum diameter of the image-side retainer is Di, a minimum diameter of the light blocking surface is Ds, and the following condition is satisfied:
$$0.03 < Ds / ( Do + D i ) < 0.75 .$$

2. The imaging lens assembly of claim 1, wherein the minimum diameter of the object-side retainer is Do, the minimum diameter of the image-side retainer is Di, the minimum diameter of the light blocking surface is Ds, and the following condition is satisfied:
$$0.05 < Ds / ( Do + D i ) < 0.55 .$$

3. The imaging lens assembly of claim 2, wherein the minimum diameter of the object-side retainer is Do, the minimum diameter of the image-side retainer is Di, the minimum diameter of the light blocking surface is Ds, and the following condition is satisfied:
$$0.08 < Ds / ( Do + D i ) < 0.45 .$$

4. The imaging lens assembly of claim 1, wherein the object-side lens element is made of a glass material, and the image-side lens element is made of a plastic material.

5. The imaging lens assembly of claim 1, wherein the object-side lens element comprises a convex surface, and the convex surface faces towards the object side of the imaging lens assembly.

6. The imaging lens assembly of claim 1, wherein the object-side abutting portion of the object-side retainer has a first alignment structure, the object-side lens element has a second alignment structure, and the first alignment structure and the second alignment structure rely to each other so as to align the object-side lens element to the optical axis of the imaging lens assembly.

7. The imaging lens assembly of claim 1, wherein the annular light blocking structure is disposed on the inner peripheral portion of the plastic lens barrel, and the annular light blocking structure on the inner peripheral portion extends from the inner peripheral portion to the optical axis.

8. The imaging lens assembly of claim 1, wherein the annular light blocking structure is disposed on a spacer of the imaging lens assembly, and the spacer is disposed between two of the lens elements.

9. The imaging lens assembly of claim 1, wherein the image-side retainer comprises:
an image-side retaining portion surrounding the outer peripheral portion of the plastic lens barrel; and
an image-side abutting portion extending from the image-side retaining portion towards the optical axis, and abutting the image-side lens element.

10. The imaging lens assembly of claim 1, wherein a distance between the object-side surface and the image-side surface in a direction parallel to the optical axis is La, the minimum diameter of the light blocking surface is Ds, and the following condition is satisfied:
$$0.02 < La / Ds < 1 .$$

11. The imaging lens assembly of claim 10, wherein the distance between the object-side surface and the image-side surface in the direction parallel to the optical axis is La, the minimum diameter of the light blocking surface is Ds, and the following condition is satisfied:
$$0.03 < La / Ds < 0.8 .$$

12. The imaging lens assembly of claim 1, wherein the minimum diameter of the object-side retainer is Do, the minimum diameter of the image-side retainer is Di, the minimum diameter of the light blocking surface is Ds, and the following condition is satisfied:
$$\vert Do - Di \vert < Ds .$$

13. The imaging lens assembly of claim 1, wherein an angle formed between each of the strip-shaped wedge structures and the optical axis is As, and the following condition is satisfied:
0 degrees≤As<60 degrees.

14. The imaging lens assembly of claim 13, wherein the angle formed between each of the strip-shaped wedge structures and the optical axis is As, and the following condition is satisfied:
$$0 degrees \leq A s < 45 degrees .$$

15. A camera module, comprising:
the imaging lens assembly of claim 1.

16. An electronic device, comprising:
the camera module of claim 15.

17. A mobile transportation, comprising:
the camera module of claim 15.

18. An imaging lens assembly having an optical axis, and comprising:
a plurality of lens elements disposed in order along the optical axis, wherein the lens elements comprise an object-side lens element and an image-side lens element;
an annular light blocking structure, wherein the object-side lens element, the annular light blocking structure and the image-side lens element are disposed in order along the optical axis from an object side of the imaging lens assembly to an image side of the imaging lens assembly, and the annular light blocking structure comprises:
a light blocking surface disposed around and facing towards the optical axis;
an object-side surface facing towards the object side of the imaging lens assembly, and extending from the light blocking surface in a direction away from the optical axis;
an image-side surface facing towards the image side of the imaging lens assembly, and extending from the light blocking surface in the direction away from the optical axis; and
a plurality of strip-shaped wedge structures disposed on the light blocking surface, wherein each of the strip-shaped wedge structures extends from the object-side surface to the image-side surface, the strip-shaped wedge structures are arranged in a direction surrounding the optical axis, each of the strip-shaped wedge structures comprises a tapering portion, and the tapering portion tapers towards the optical axis;
a plastic lens barrel, wherein the lens elements and the annular light blocking structure are disposed in the plastic lens barrel, and the plastic lens barrel comprises:
an object-side portion facing towards the object side of the imaging lens assembly and forming an object-side opening, wherein the object-side lens element is placed into the plastic lens barrel from the object-side opening to the object-side surface;
an image-side portion facing towards the image side of the imaging lens assembly and forming an image-side opening, wherein the image-side lens element is placed into the plastic lens barrel from the image-side opening to the image-side surface;
an inner peripheral portion connecting the object-side portion and the image-side portion, and disposed facing towards the optical axis; and
an outer peripheral portion connecting the object-side portion and the image-side portion, and disposed corresponding to the inner peripheral portion in the direction away from the optical axis;
an object-side retainer disposed on the object-side portion of the plastic lens barrel, and comprising:
an object-side retaining portion surrounding the outer peripheral portion of the plastic lens barrel; and
an object-side abutting portion extending from the object-side retaining portion towards the optical axis, and abutting the object-side lens element so as to fix the object-side lens element to the object-side portion of the plastic lens barrel; and
an image-side retainer disposed on the image-side portion of the plastic lens barrel so as to fix the image-side lens element to the image-side portion of the plastic lens barrel;
wherein a distance between the object-side abutting portion of the object-side retainer and the object-side surface of the annular light blocking structure in a direction parallel to the optical axis is Lr, a length of the object-side retainer in the direction parallel to the optical axis is Lo, and the following condition is satisfied:
$$0.15 < Lr / Lo < 1 .$$

19. The imaging lens assembly of claim 18, wherein the distance between the object-side abutting portion of the object-side retainer and the object-side surface of the annular light blocking structure in the direction parallel to the optical axis is Lr, the length of the object-side retainer in the direction parallel to the optical axis is Lo, and the following condition is satisfied:
$$0.2 < Lr / Lo < 0.85 .$$

20. The imaging lens assembly of claim 18, wherein a minimum diameter of the object-side retainer is Do, a minimum diameter of the image-side retainer is Di, a minimum diameter of the light blocking surface is Ds, and the following condition is satisfied:
$$0.03 < Ds / ( Do + D i ) < 0.75 .$$

21. The imaging lens assembly of claim 20, wherein the minimum diameter of the object-side retainer is Do, the minimum diameter of the image-side retainer is Di, the minimum diameter of the light blocking surface is Ds, and the following condition is satisfied:
$$0.05 < Ds / ( Do + D i ) < 0.55 .$$

22. The imaging lens assembly of claim 21, wherein the minimum diameter of the object-side retainer is Do, the minimum diameter of the image-side retainer is Di, the minimum diameter of the light blocking surface is Ds, and the following condition is satisfied:
$$0.08 < Ds / ( Do + D i ) < 0.45 .$$

23. The imaging lens assembly of claim 18, wherein the object-side lens element is made of a glass material, and the image-side lens element is made of a plastic material.

24. The imaging lens assembly of claim 18, wherein the object-side abutting portion of the object-side retainer has a first alignment structure, the object-side lens element has a second alignment structure, and the first alignment structure and the second alignment structure rely to each other so as to align the object-side lens element to the optical axis of the imaging lens assembly.

25. The imaging lens assembly of claim 18, wherein the annular light blocking structure is disposed on the inner peripheral portion of the plastic lens barrel, and the annular light blocking structure on the inner peripheral portion extends from the inner peripheral portion to the optical axis.

26. The imaging lens assembly of claim 18, wherein the annular light blocking structure is disposed on a spacer of the imaging lens assembly, and the spacer is disposed between two of the lens elements.

27. The imaging lens assembly of claim 18, wherein the image-side retainer comprises:
an image-side retaining portion surrounding the outer peripheral portion of the plastic lens barrel; and
an image-side abutting portion extending from the image-side retaining portion towards the optical axis, and abutting the image-side lens element.

28. The imaging lens assembly of claim 18, wherein a minimum diameter of the object-side retainer is Do, a minimum diameter of the image-side retainer is Di, a minimum diameter of the light blocking surface is Ds, and the following condition is satisfied:
$$\vert Do - Di \vert < Ds .$$

29. The imaging lens assembly of claim 18, wherein an angle formed between each of the strip-shaped wedge structures and the optical axis is As, and the following condition is satisfied:
$$0 degrees \leq As < 60 degrees .$$

30. The imaging lens assembly of claim 29, wherein the angle formed between each of the strip-shaped wedge structures and the optical axis is As, and the following condition is satisfied:
$$0 degrees \leq A s < 45 degrees .$$
